(19) United States
(12) Patent Application Publication
(10) Pub. No.: US 2025/0280244 A1
(43) Pub. Date: Sep. 4, 2025

(54) Apparatus

(71) Applicant: LG Display Co., Ltd., Seoul (KR)

(72) Inventors: Tae Hyung Kim, Paju-si (KR); Gyung Bo Ha, Paju-si (KR)

(21) Appl. No.: 19/056,504

(22) Filed: Feb. 18, 2025

(30) Foreign Application Priority Data
Feb. 29, 2024 (KR) 10-2024-0029935

(51) Int. Cl. H04R 17/00; H04R 7/18

(52) U.S. Cl. CPC H04R 17/00; H04R 7/18

(57) ABSTRACT

An apparatus is disclosed. The apparatus includes a housing including an internal space, a plurality of first sub-plates disposed in the internal space, a plurality of first vibration elements each disposed on one of the plurality of first sub-plates, and a vibration member disposed on the plurality of first sub-plates and the plurality of first vibration elements, wherein the plurality of first sub-plates have one sides connected to the housing and the other sides connected to the vibration member.

### CROSS-REFERENCE TO RELATED APPLICATION

This application claims priority to and the benefit of Republic of Korea Patent Application No. 10-2024-0029935 filed on Feb. 29, 2024, which is hereby incorporated by reference in its entirety.

### BACKGROUND

### Field

The present specification relates to an apparatus, and more specifically, to an apparatus for outputting acoustic waves.

### Description of Related Art

An apparatus includes a separate speaker or acoustic device to provide acoustic waves. The acoustic device has a vibration system for converting an input electric signal into physical vibrations. A piezoelectric speaker formed of a piezoelectric element has advantages of being lightweight and low power consumption and thus is used for various purposes.

The piezoelectric element used in the piezoelectric speaker tends to have an insufficient sound pressure in a low sound band because the lowest resonant frequency increases due to high stiffness. Since the piezoelectric speaker has a technical problem of insufficient sound pressure in the low sound band, the apparatus including the piezoelectric speaker has a problem of insufficient sound pressure in the low sound band.

### SUMMARY

The present specification provides an apparatus capable of improving acoustic characteristics and/or sound pressure characteristics in a low sound band.

The present specification provides an apparatus capable of improving acoustic characteristics and/or sound pressure characteristics in a low sound band, a medium sound band, and a high sound band.

The objects of the present specification are not limited to the above-described objects, and other objects that are not described will be able to be clearly understood by those skilled in the art from the following description.

An apparatus according to an embodiment of the present specification includes a housing including an internal space, a plurality of first sub-plates disposed in the internal space, a plurality of first vibration elements each disposed on one of the plurality of first sub-plates, and a vibration member disposed on the plurality of first sub-plates and the plurality of first vibration elements. The plurality of first sub-plates have one sides connected to the housing and the other sides connected to the vibration member.

Detailed items according to various examples of the present specification other than the above-described configuration are included in the following description and the accompanying drawings.

According to one embodiment of the present specification, it is possible to improve the acoustic characteristics and/or sound pressure characteristics in the low sound band.

According to one embodiment of the present specification, it is possible to improve the sound pressure of the apparatus by adjusting the material, stiffness, weight, and the like of the vibration member and/or the transmission member.

According to one embodiment of the present specification, it is possible to improve the sound pressure in the low sound band and the medium/high sound bands of the apparatus by vibrating each of the vibration member and the sub-plate.

According to one embodiment of the present specification, it is possible to enable uni-materialization by forming the vibration element as a single component.

The effects of the present specification are not limited to the above-described effects, and other effects that are not described will be able to be clearly understood by those skilled in the art from the following description.

### BRIEF DESCRIPTION OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a perspective view showing an apparatus according to a first embodiment of the present specification;

FIG. 2 is an exploded perspective view of FIG. 1 according to one embodiment of the present specification;

FIG. 3 is a cross-sectional view along line I-I′ in FIG. 1 according to one embodiment of the present specification;

FIG. 4 is an enlarged view of a portion of FIG. 3 according to one embodiment of the present specification;

FIG. 5 is an enlarged view of a portion of FIG. 1 according to one embodiment of the present specification;

FIG. 6 is a view showing a state in which a plurality of transmission members are disposed in a vibration member according to one embodiment of the present specification;

FIG. 7 is a diagram showing the apparatus according to one embodiment of the present specification;

FIG. 8 is a diagram showing the apparatus according to one embodiment of the present specification;

FIG. 9 is a diagram showing the apparatus according to one embodiment of the present specification;

FIG. 10 is a perspective view showing an apparatus according to a second embodiment of the present specification;

FIG. 11 is an enlarged view of a portion of FIG. 10 according to one embodiment of the present specification;

FIG. 12 is a view showing a state in which a plurality of transmission members are disposed in a vibration member;

FIG. 13 is a perspective view showing an apparatus according to a third embodiment of the present specification;

FIG. 14 is an exploded perspective view of FIG. 13 according to one embodiment of the present specification;

FIG. 15 is a cross-sectional view along line II-II′ in FIG. 13 according to one embodiment of the present specification;

FIG. 16 is an enlarged view of a portion of FIG. 15 according to one embodiment of the present specification;

FIG. 17 is a diagram showing a state in which a power source is connected to a vibration element according to the third embodiment of the present specification;

FIG. 18 is a diagram showing the apparatus according to one embodiment of the present specification;

FIG. 19 is a diagram showing the apparatus according to one embodiment of the present specification;

FIG. 20 is a diagram showing the apparatus according to one embodiment of the present specification;

FIG. 21 is a diagram showing a vibration device according to one embodiment of the present specification;

FIG. 22 is a cross-sectional view along line III-III′ in FIG. 21 according to one embodiment of the present specification;

FIG. 23 is a cross-sectional view along line IV-IV′ in FIG. 21 according to one embodiment of the present specification;

FIG. 24 is a diagram showing a vibration part according to another embodiment of the present specification;

FIG. 25 is a diagram showing a vibration part according to still another embodiment of the present specification;

FIG. 26 is a diagram showing a vibration device according to another embodiment of the present specification;

FIG. 27 is a diagram showing an acoustic output characteristic according to one embodiment of the present specification;

FIG. 28 is a diagram showing an acoustic output characteristic according to one embodiment of the present specification;

FIG. 29 is a diagram showing an acoustic output characteristic according to one embodiment of the present specification; and

FIG. 30 is a diagram showing a driving part according to one embodiment of the present specification.

### DETAILED DESCRIPTION

Advantages and features of the present specification and methods for achieving them will become clear with reference to embodiments described below in detail in conjunction with the accompanying drawings. However, the present specification is not limited to embodiments disclosed below but will be implemented in various different forms, these embodiments are merely provided to make the disclosure of the present specification complete and fully inform those skilled in the art to which the present specification pertains of the scope of the present specification.

Since shapes, sizes, ratios, angles, numbers, and the like disclosed in the drawings for describing the embodiments of the present specification are illustrative, the present specification is not limited to the illustrated items. The same reference number denotes the same components throughout the specification. In addition, in describing the present specification, when it is determined that the detailed description of a related known technology may unnecessarily obscure the gist of the present specification, detailed description thereof will be omitted. When “comprise,” “have,” “include,” or the like described herein are used, other parts may be added unless “only” is used. When a component is expressed in the singular, it includes a case in which the component is provided as a plurality of components unless specifically stated otherwise.

In construing a component, the component is construed as including the margin of error even when there is no separate explicit description about the margin of error.

When the positional relationship is described, for example, when the positional relationship between two parts is described using “on,” “above,” “under,” “next to,” or the like, one or more other parts may be positioned between the two parts unless “immediately” or “directly” is used.

When the temporal relationship is described, when the temporal relationship is described using “after,” “subsequently,” “then,” “before,” or the like, it may also include a non-consecutive case unless “immediately” or “directly” is used.

Although a first, a second, and the like are used to describe various components, these components are not limited by these terms. These terms are only used to distinguish one component from another component. Therefore, a first component described below may be a second component within the technical spirit of the present specification.

In the description of the components of the present specification, terms such as first, second, A, B, (a), and (b) may be used. These terms are only for the purpose of distinguishing one component from another component, and the nature, sequence, order, or the like of the corresponding component is not limited by these terms. When a certain component is described as being “connected,” “coupled,” or “joined” to another component, the certain component may be connected or joined directly to another component, but it should be understood that other components may be “interposed” between the certain component and another component, which may be connected or coupled indirectly unless otherwise stated specially.

It should be understood that “at least one” includes any combination of one or more of associated components. For example, “at least one of first, second, and third components” may include not only the first, second, or third component, but also any combination of two or more of the first, second, and third components.

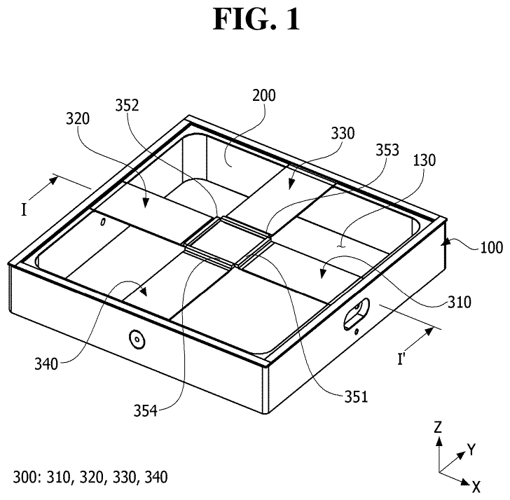

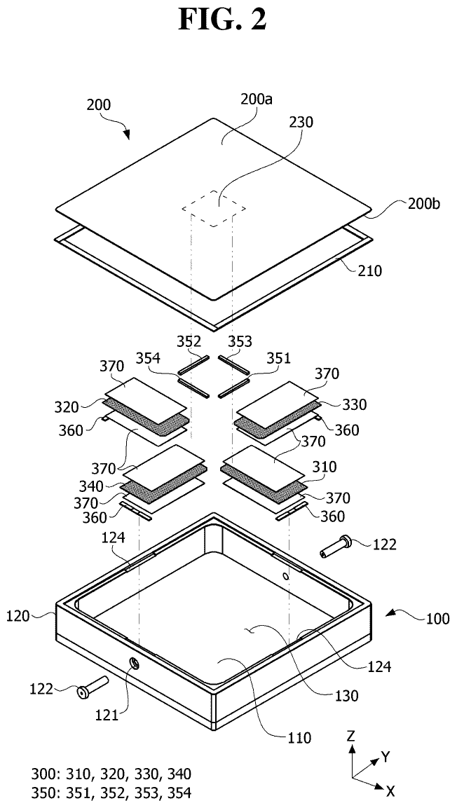

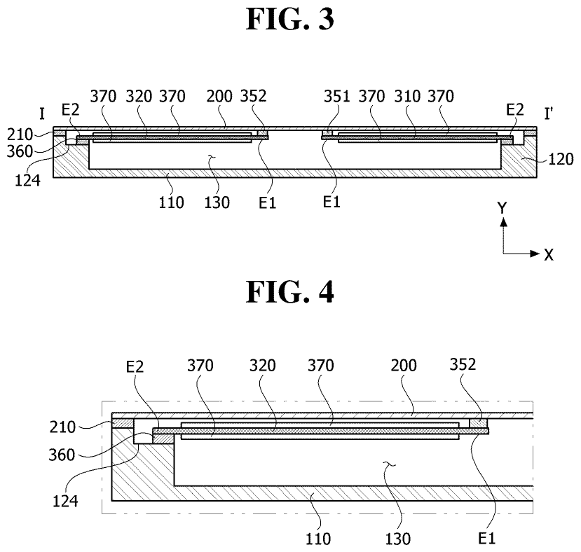

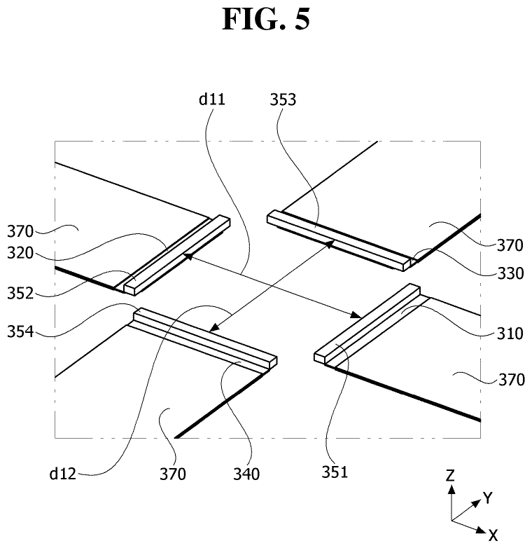

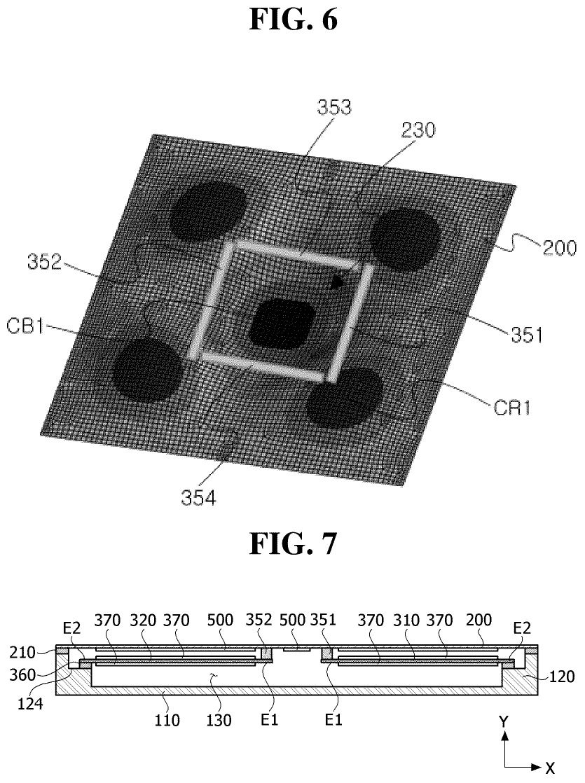

FIG. 1 is a perspective view showing an apparatus according to a first embodiment of the present specification. FIG. 2 is an exploded perspective view of FIG. 1 according to one embodiment of the present specification. FIG. 3 is a cross-sectional view along line I-I′ FIG. 1 according to one embodiment of the present specification. FIG. 4 is an enlarged view of a portion of FIG. 3 according to one embodiment of the present specification. FIG. 5 is an enlarged view of a portion of FIG. 1 according to one embodiment of the present specification. FIG. 6 is a view showing a state in which a plurality of transmission members are disposed in a vibration member according to one embodiment of the present specification.

An apparatus according to an embodiment of the present specification may implement or achieve an acoustic apparatus, an acoustic output apparatus, a vibration apparatus, a vibration generating apparatus, a sound bar, an acoustic system, an acoustic apparatus for an electronic apparatus, an acoustic apparatus for a display, an acoustic apparatus for a transportation apparatus, or a sound bar for a transportation apparatus.

For example, the transportation apparatus may include one or more seats and one or more glass windows. For example, the transportation apparatus may include a vehicle, a train, a ship, or an aircraft, and the embodiments of the present specification are not limited thereto.

In addition, the apparatus according to the embodiment of the present specification may implement or achieve an analog signage, such as an advertising signboard, a poster, a guide board, a digital signage, or the like.

The apparatus according to one embodiment of the present specification may be a display apparatus including a plurality of pixels, but the embodiments of the present specification are not limited thereto.

The display apparatus may include a display panel including a plurality of pixels forming black and white or color images, and a driver for driving the display panel. The pixel may be a sub-pixel forming one of a plurality of colors forming color images. The apparatus according to the embodiment of the present specification may include an equipment apparatus including a notebook computer, a television, a computer monitor, a vehicle or automotive apparatus, or other forms for a vehicle, which is a complete product or final product including a display panel such as a liquid display panel, an organic light emitting display panel, or a micro light emitting diode (LED) display panel, or a set electronic apparatus or a set apparatus of a mobile electronic apparatus such as a smartphone or an electronic pad.

Referring to FIGS. 1 to 4, the apparatus according to the embodiment may include a housing 100, a plurality of first sub-plates 300, a plurality of first vibration elements 370, and a vibration member 200.

The vibration member 200 may generate vibrations or output acoustic waves (or sound waves) according to displacement. The vibration member 200 may be a vibration target, a display member, a display panel, a signage panel, a passive vibration member, a passive vibration plate, a vibration panel, a sound panel, a passive vibration panel, an acoustic output plate, an acoustic vibration plate, or a video screen, but the embodiments of the present specification are not limited thereto.

The housing 100 may include a bottom portion 110 and a side wall portion 120. The bottom portion 110 may form a bottom surface. The side wall portion 120 may surround the bottom portion 110. The bottom portion 110 and the side wall portion 120 may be formed integrally, but are not necessarily limited thereto. For example, the bottom portion 110 and the side wall portion 120 may be assembled by being manufactured separately. The bottom portion 110 and the side wall portion 120 may be made of the same material or different materials.

The housing 100 may include a surrounded internal space 130. The housing 100 may include the internal space 130 surrounded by the bottom portion 110 and the side wall portion 120. The internal space 130 may be an empty space in the housing 100. When the bottom portion 110 and the side wall portion 120 are formed integrally, the internal space 130 may be a groove formed in the housing 100. For example, the housing 100 may be a case, an outer case, a case member, a cabinet, an enclosure, a sealing member, a sealing cap, a sealing box, a sound box, or the like, but the embodiments of the present specification are not limited thereto. For example, the internal space 130 of the housing 100 may be an accommodating space, a storing space, a gap space, an air space, a vibration space, an acoustic space, a sound box, a cavity, a sealed space, or the like, but the embodiments of the present specification are not limited thereto.

According to an embodiment, the housing 100 may have a quadrangular shape, but is not necessarily limited thereto. The shape of the housing 100 may be a polygonal shape such as a triangle or hexagonal shape, a circular or elliptical shape, and a curved shape having various curvatures.

The bottom portion 110 of the housing 100 may be spaced apart from a second surface 200b of the vibration member 200 with the internal space 130 interposed therebetween. The side wall portion 120 of the housing 100 may be connected to an edge portion of the bottom portion 110. For example, the side wall portion 120 may include a structure bent from the edge portion of the bottom portion 110, but the embodiments of the present specification are not limited thereto. For example, the side wall portion 120 may be parallel to a third direction (Z-axis direction) or inclined with respect to the third direction (Z-axis direction).

The vibration member 200 may include the first surface 200a and the second surface 200b. The first surface 200a may output acoustic waves. The second surface 200b may be a surface opposite to the first surface 200a. Each of the first surface 200a and the second surface 200b of the vibration member 200 may include a planar structure, but the embodiments of the present specification are not limited thereto. The vibration member 200 may include a structure having an overall uniform thickness, but the embodiments of the present specification are not limited thereto.

The vibration member 200 according to one embodiment of the present specification may be formed to be transparent, translucent, or opaque. The vibration member 200 may include a metallic material having material properties suitable for outputting acoustic waves according to vibrations or include a non-metallic material (or a composite non-metallic material), but the embodiments of the present specification are not limited thereto. The metallic material of the vibration member 200 may include one or more of stainless steel, aluminum (Al), an aluminum (Al) alloy, magnesium (Mg), a magnesium (Mg) alloy, a magnesium lithium (Mg—Li) alloy, and plastic, but the embodiments of the present specification are not limited thereto.

The vibration member 200 may include a material having an elastic modulus ranging from 50 GPa to 110 GPa, a density ranging from 1000 kg/m³ to 3000 kg/m³, and a specific stiffness ranging from 30 MPa×m³/kg to 70 MPa×m³/kg. For example, the vibration member 200 may be made of a carbon fiber reinforced plastics (CFRP) material having excellent specific stiffness, but the embodiments of the present specification are not limited thereto. Although the thickness of the vibration member 200 may range from 0.1 mm to 1.0 mm, the thickness of the vibration member 200 is not necessarily limited thereto.

The housing 100 may be connected or coupled to the vibration member 200 via a first coupling member 210. The housing 100 may be connected or coupled to the second surface 200b of the vibration member 200 via the first coupling member 210.

The first coupling member 210 may be formed to minimize, reduce, or prevent the vibrations of the vibration member 200 from being transmitted to the housing 100. The first coupling member 210 may include material characteristics suitable for blocking vibrations. For example, the first coupling member 210 may include an elastic material for vibration absorption (or shock absorption).

The first coupling member 210 according to one embodiment of the present specification may be made of a polyurethane material or a polyolefin material, but the embodiments of the present specification are not limited thereto. For example, the first coupling member 210 may include one or more of an adhesive, a double-sided tape, a double-sided foam tape, a double-sided foam pad, and a double-sided cushion tape, but the embodiments of the present specification are not limited thereto.

The first coupling member 210 according to one embodiment of the present specification may prevent physical contact (or friction) between the vibration member 200 and the side wall portion 120 of the housing 100, thereby preventing the generation of noise (or noise). For example, the first coupling member 210 may be a buffering member, an elastic member, a damping member, a vibration absorbing member, a vibration preventing member, or a vibration blocking member, but the embodiments of the present specification are not limited thereto.

The plurality of first sub-plates 300 may be disposed in the internal space 130 of the housing 100 to transmit vibrations to the vibration member 200. In the apparatus according to the embodiment of the present specification, the vibration member 200 may vibrate by vibrations generated from the plurality of first sub-plates 300 without directly vibrating by the vibration element. In the apparatus according to the present specification, since the vibration member 200 vibrates by the plurality of first sub-plates 300, a resonant frequency of the vibration member may be freely adjusted by changing the stiffness and/or weight of the vibration member. Therefore, it is possible to improve the sound pressure in the low sound band.

The plurality of first sub-plates 300 may have a predetermined length from an edge of the housing 100 to the center thereof. The plurality of first sub-plates 300 may include an elastic metallic material or a non-metallic material (or a composite non-metallic material), but the embodiments of the present specification are not limited thereto.

The plurality of first sub-plates 300 may include a material having an elastic modulus ranging from 1 GPa to 3 GPa, a density ranging from 500 kg/m³ to 2000 kg/m³, and a specific stiffness ranging from 1 MPa×m³/kg to 5 MPa×m³/kg, but the embodiments of the present specification are not limited thereto. For example, the first sub-plate 300 may be made of an acrylonitrile butadiene styrene (ABS) material, but the embodiments of the present specification are not limited thereto. The vibration member 200 may be disposed on the plurality of first sub-plates 300. When the vibration member 200 is made of CFRP, the vibration member 200 may have greater specific stiffness than the first sub-plate 300. As a result, the number of resonance modes during vibrations of the vibration member 200 is reduced, which may reduce the peaks or dips of the acoustic waves (or sound pressure) generated by the vibrations.

The thickness of the plurality of first sub-plates 300 may range from 0.5 mm to 2.0 mm, but the embodiments of the present specification are not limited thereto. The plurality of first sub-plates 300 may be formed to have higher stiffness and larger thickness than the vibration member 200, but the embodiments of the present specification are not limited thereto. For example, the stiffness of the plurality of first sub-plates 300 may be the same as or smaller than that of the vibration member 200, but the embodiments of the present specification are not limited thereto. For example, the thickness of the plurality of first sub-plates 300 may be the same as or smaller than that of the vibration member 200, but the embodiments of the present specification are not limited thereto.

One side E2 of the plurality of first sub-plates 300 may be connected or fixed to the housing 100. The other sides E1 of the plurality of first sub-plates 300 may be connected or fixed to the second surface 200b of the vibration member 200. The plurality of first sub-plates 300 may be disposed to be spaced apart from each other so as not to overlap each other. For example, the plurality of first sub-plates 300 may be disposed to be spaced apart from each other so as not to overlap each other in a plan view.

The one side E2 of each of the plurality of first sub-plates 300 may be connected or fixed to each of the plurality of stepped portions 124 formed on the side wall portion 120 of the housing 100. A second coupling member 360 may be disposed between the stepped portion 124 and the plurality of first sub-plates 300. The second coupling member 360 may be made of a plastic material, but the embodiments of the present specification are not limited thereto. The second coupling member 360 may be made of a polycarbonate material, a polyurethane material, a polyolefin material, or a styrene material, but the embodiments of the present specification are not limited thereto. The styrene material may be an ABS material. The ABS material may be acrylonitrile, butadiene, and styrene. For example, the second coupling member 360 may include one or more of an adhesive, a double-sided tape, a double-sided foam tape, a double-sided foam pad, and a double-sided cushion tape, but the embodiments of the present specification are not limited thereto. As shown in FIG. 4, the first coupling member 210 does not overlap the second coupling member 360.

The other sides E1 of the plurality of first sub-plates 300 may be attached to the second surface 200b of the vibration member 200 by a first transmission member 350. The thickness of the first transmission member 350 may be greater than the thickness of the plurality of sub-plates 300, but the embodiments of the present specification are not limited thereto.

The first transmission member 350 may be made of any material capable of transmitting the vibrations of the plurality of first sub-plates 300 to the vibration member 200. For example, the first transmission member 350 may be made of a material such as polycarbonate (PC), but is not necessarily limited thereto. For example, the first transmission member 350 may be made of a soft material such as foam, foamed urethane, or sponge, but the embodiments of the present specification are not limited thereto. For example, the first transmission member 350 may be made of polycarbonate (PC), ABS, urethane, or a plastic material having relatively medium strength, but the embodiments of the present specification are not limited thereto. For example, the first transmission member 350 may be made of a high-strength material such as brass, copper, tungsten, aluminum, SUS, or steel series, but the embodiments of the present specification are not limited thereto.

The number of plurality of first sub-plates 300 is not particularly limited. For example, the number of plurality of first sub-plates 300 may be changed variously such as 2, 4, or 6. Hereinafter, although an example in which four first sub-plates are disposed will be described, the embodiments of the present specification are not limited thereto.

The plurality of first sub-plates 300 may include a quadrangular shape, but the embodiments of the present specification are not limited thereto. For example, the plurality of first sub-plates 300 may include a quadrangular shape having a first length parallel to a first direction (X-axis direction) and a second length parallel to a second direction (Y-axis direction). For example, the plurality of first sub-plates 300 may include a rectangular shape in which the first length differs from the second length, but the embodiments of the present specification are not limited thereto.

The plurality of first sub-plates 300 may include a first-first sub-plate 310 and a first-second sub-plate 320 facing each other in the first direction (X-axis direction), and a first-third sub-plate 330 and a first-fourth sub-plate 340 facing each other in the second direction (Y-axis direction). The first direction (X-axis direction) and the second direction (Y-axis direction) may be perpendicular, but may intersect at an angle rather than a right angle.

The first vibration element 370 may be disposed on each of the first-first to first-fourth sub-plates 310, 320, 330, and 340. The first vibration element 370 may be disposed on one surface and/or the other surfaces of the first-first to first-fourth sub-plates 310, 320, 330, and 340.

The plurality of first vibration elements 370 may be disposed on the plurality of first sub-plates 300, respectively. The plurality of first vibration elements 370 may vibrate the first-first to first-fourth sub-plates 310, 320, 330, and 340. The plurality of first vibration elements 370 may each be disposed on one of the first-first to first-fourth sub-plates 310, 320, 330, and 340. The plurality of first vibration elements 370 may be formed to vibrate (or displace or drive) according to an applied driving signal (or an electric signal or a voice signal) to vibrate (or displace) the first-first to first-fourth sub-plates 310, 320, 330, and 340. For example, the plurality of first vibration elements 370 may be an active vibration member, a vibration generator, a vibration structure, a vibrator, a vibration generating element, an acoustic generator, an acoustic element, an acoustic generating structure, or an acoustic generating element, but the embodiments of the present specification are not limited thereto.

The plurality of first vibration elements 370 according to one embodiment of the present specification may include a rectangular shape, but the embodiments of the present specification are not limited thereto.

The plurality of first vibration elements 370 may each be attached to one of the first-first to first-fourth sub-plates 310, 320, 330, and 340. The adhesive member may include a foam pad, a double-sided tape, a double-sided foam pad, a double-sided foam tape, an adhesive, a double-sided adhesive tape, a double-sided adhesive foam pad, an adhesive sheet, or the like, and the embodiments of the present specification are not limited thereto.

When power is applied to the first vibration elements 370 disposed on the first-first to first-fourth sub-plates 310, 320, 330, and 340, the first-first to first-fourth sub-plates 310, 320, 330, and 340 may vibrate. In this case, since the one side E2 of the first-first to first-fourth sub-plates 310, 320, 330, and 340 are connected or fixed to the housing 100, the other side E1 of the first-first to first-fourth sub-plates 310, 320, 330, and 340 vibrate vertically, and exciting forces may be transmitted to the vibration member 200.

Lengths of the first-first to first-fourth sub-plates 310, 320, 330, and 340 may be the same. Therefore, the first-first to first-fourth sub-plates 310, 320, 330, and 340 have the same resonant frequency and phase, and thus may generate vibrations in the same sound band. The vibration member 200 may generate acoustic waves (sound pressure) according to the vibrations of the first-first to first-fourth sub-plates 310, 320, 330, and 340.

The first-first to first-fourth sub-plates 310, 320, 330, and 340 may have a cantilever structure in which one side E2 is connected or fixed and the other side E1 vibrates. The vibration member 200 may have a lower resonance frequency by being connected to the first-first to first-fourth sub-plates 310, 320, 330, and 340. Therefore, it is possible to improve the acoustic characteristics and/or sound pressure characteristics in the low sound band generated according to the vibrations of the vibration member 200.

Referring to FIG. 5, the first-first sub-plate 310 and the first-second sub-plate 320 may be disposed to face each other in the first direction (X-axis direction). The first-third sub-plate 330 and the first-fourth sub-plate 340 may be disposed to face each other in the second direction (Y-axis direction).

A first spacing d11 between the first-first sub-plate 310 and the first-second sub-plate 320 may be the same as a second spacing d12 between the first-third sub-plate 330 and the first-fourth sub-plate 340, but the embodiments of the present specification are not limited thereto.

Therefore, a distance between a first-first transmission member 351 and a first-second transmission member 352 may be the same as a distance between a first-third transmission member 353 and a first-fourth transmission member 354, and the first-first to first-fourth transmission members 351, 352, 353, and 354 may be disposed in a form that surrounds a central portion 230 of the vibration member 200. The first-first to first-fourth transmission members 351, 352, 353, and 354 may be disposed at a point where a local mode (tertiary resonance mode) of the vibration member 200 may be minimized or at least reduced. Thus, the effective vibrating area of the vibrating member 200 may be increased, which may result in improved sound pressure.

The resonance frequency of the vibration member 200 may be adjusted by the mass (M) and stiffness (K). The larger the mass and the smaller the stiffness, the lower the resonance frequency may be. The sound pressure may be greatly affected by the area of the vibration member 200 and the amplitude of the vibration member 200. When the stiffness of the vibration member 200 is small (when the specific stiffness is high), the resonance frequency of the vibration member 200 decreases, but an actual effective vibration area may decrease due to the local mode, thereby reducing the sound pressure. When the stiffness of the vibration member 200 is great, the resonant frequency increases, but the actual amplitude of the vibration member 200 may decrease due to the stiffness, thereby reducing the sound pressure. When the mass of the vibration member 200 increases, the resonant frequency decreases, but since an exciting force of the vibration element is insufficient compared to the mass, the amplitude thereof decreases, and thus the sound pressure decreases.

Since the structure of directly attaching the vibration element to the vibration member is to attach a plurality of vibration elements to the vibration member for reducing the local mode, so the vibration dispersion area of the vibration member increases due to the connection structure of the vibration member and the wide adhesive structure of the vibration element, and there is a problem that an additional weight member is required to achieve the desired resonant frequency.

In addition, since the vibration element and the weight member are directly attached to the vibration member, the mass and stiffness change depending on the attachment method and structure, and thus there is a problem that tuning using the mass and stiffness becomes difficult.

Since the cantilever structure according to the embodiment transmits the vibrations of the sub-plate to the vibration member 200, it has the advantages that the stiffness and weight of the vibration member may be freely changed, the resonant frequency may be easily tuned, and all the excitation forces generated by the sub-plate may be used.

In addition, since vibrations is applied to the central portion 230 of the vibration member 200 with high non-stiffness in any direction, there is an advantage that the vibration member 200 may secure a wide effective vibration area, thereby amplifying the sound pressure.

Referring to FIG. 6, the vibration member 200 may have a tertiary resonance mode in which a blue concave portion CB1 is formed in the central portion 230 and a red convex portion CR1 is formed near four corners. Green and yellow portions between the blue and red may be curved portions connecting the concave portion CB1 to the convex portion CR1. According to an embodiment, the first-first to first-fourth transmission members 351, 352, 353, and 354 may be disposed to be spaced a predetermined distance from the center portion 230 of the vibration member, thereby suppressing the formation of the concave portion in the center portion 230. As a result, a primary vibration mode may be improved and the local mode (tertiary vibration mode) may be reduced. Therefore, one or more of the peak and dip generated in a reproduction frequency band of the acoustic waves (or sound pressure) generated by the vibrations of the vibration member 200 may be reduced.

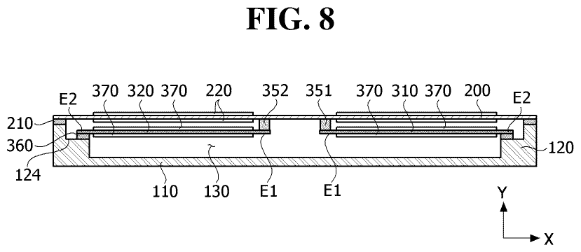

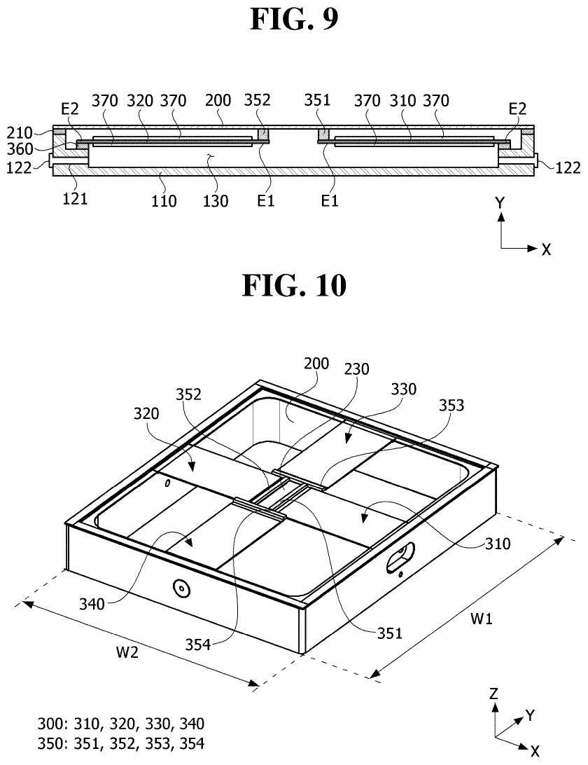

FIGS. 7 to 9 are views showing an apparatus according to an embodiment of the present specification. FIG. 7 is a diagram showing a state in which a vibration member and a weight member are disposed according to one embodiment of the present specification. FIG. 8 is a diagram showing a state in which the vibration member and a vibration element are disposed according to one embodiment of the present specification. FIG. 9 is a diagram showing a duct disposed in a housing according to one embodiment of the present specification.

Referring to FIG. 7, a weight member 500 may be disposed between the vibration member 200 and a plurality of first sub-plates 300. The weight member 500 may increase the weight of the vibration member 200 to decrease the lowest resonant frequency (or lowest natural frequency) of the vibration member 200. As a result, the vibration member 200 may vibrate at a relatively low frequency due to a decrease in the lowest resonant frequency (or lowest natural frequency) as a result of the increase in weight caused by the weight member 500. This may improve the acoustic characteristics and/or sound pressure characteristics in the low sound band generated by the vibrations. For example, the weight member 500 may be a local mass, a point mass, a resonance pad, a weight, or a mass member, and the embodiments of the present specification are not limited thereto. For example, the low sound band may be 300 Hz or lower or 500 Hz or lower, but the embodiments of the present specification are not limited thereto. The weight member 500 may be formed to correct the mode shape of the vibration member 200.

For example, the weight member 500 may be made of a metallic material. The weight member 500 may include one or more of stainless steel, aluminum (Al), an aluminum (Al) alloy, titanium, and a titanium alloy, but the embodiments of the present specification are not limited thereto.

In the embodiment, since the vibrations of the plurality of first sub-plates 300 is transmitted to the vibration member 200, the resonant frequency may be freely adjusted by adjusting the weight of the vibration member 200.

Since the local mode may easily occur in the regions between the vibration member 200 and the plurality of first sub-plates 300, the generation of the local mode may be suppressed by disposing the weight member 500 between the vibration member 200 and the plurality of first sub-plates 300.

The weight member 500 may be disposed in all regions in which the vibration member 200 and the plurality of first sub-plates 300 overlap each other. The weight member 500 may be disposed only in some regions in which the vibration member 200 and the plurality of first sub-plates 300 overlap each other. However, the embodiments of the present specification are not limited thereto. The weight member 500 may be disposed in a region other than the regions in which the vibration member 200 and the plurality of first sub-plates 300 overlap each other. For example, the weight member 500 may be disposed at a central portion of the vibration member 200 in which the plurality of first sub-plates 300 are spaced apart from each other. For example, the weight member 500 may be disposed adjacent to each corner of the housing 100.

Referring to FIG. 8, a second vibration element 220 may be attached to the vibration member 200. For example, the second vibration element 220 may be directly attached to the vibration member 200. When power is applied to the second vibration element 220, the vibration member 200 may vibrate and output acoustic waves according to the vibrations. When the first vibration element 370 and the second vibration element 220 vibrate together, the vibrations generated by the second vibration element 220 and the vibrations transmitted by the first sub-plate 300 may be synthesized. Therefore, the acoustic waves sound according to the synthesized vibrations may be output. The advantage of this configuration is that the structure in which the vibration element is directly attached to the vibration member and the cantilever structure may be combined to improve the sound pressure in the low sound band and the medium/high sound bands.

The second vibration element 220 of the vibration member 200 may be disposed on one surface and/or the other surface of the vibration member 200. The second vibration element 220 disposed on the vibration member 200 may be disposed in a region that overlaps the first vibration elements 370 disposed on the plurality of first sub-plates 300 in the third direction (Z-axis direction). Only a portion of the second vibration element 220 disposed on the vibration member 200 may or may not overlap the first vibration elements 370 disposed on the plurality of first sub-plates 300 in the third direction (Z-axis direction).

An area of the second vibration element 220 may be the same as that of the first vibration element 370. However, the embodiments of the present specification are not necessarily limited thereto, and the area of the second vibration element 220 may be greater or smaller than that of the first vibration element 370.

Referring to FIG. 9, the acoustic performance may be improved by arranging a duct 122 and/or a hole or a vent hole 121 in the housing 100. The duct 122 may be accommodated or inserted into the hole or the vent hole 121 formed in a side wall portion 120 of the housing 100. Therefore, the internal space of the apparatus or the internal space 130 provided between the vibration member 200 and the housing 100 may be connected to or may communicate with an external part by the duct 122 and/or the hole or the vent hole 121, thereby reducing the air pressure of the internal space 130. One or more ducts 122 and/or vent holes (or holes) 121 may be disposed, but the number thereof is not particularly limited. Two ducts 122 and/or vent holes (or holes) 121 may be disposed to face each other, but are not limited thereto. The duct 122 may be an elastic pad having a hole formed therein, but the embodiments of the present specification are not limited thereto.

If the duct 122 and/or the vent hole (or hole) 121 are not formed, an air flow generated each time the first vibration element 370 vibrates in a reverse direction may be offset or lost. If the duct 122 and/or the vent hole (or hole) 121 are formed, the air flow generated each time the first vibration element 370 vibrates in the reverse direction may be smooth, and the air flow may be used to amplify low sound without being offset or lost.

Therefore, by using the duct 122 and/or the vent hole (or hole) 121 to use the air generated each time the first vibration element 370 vibrates in the reverse direction for amplifying the low sound, it is possible to improve the sound pressure characteristics and/or acoustic characteristics of the low sound band.

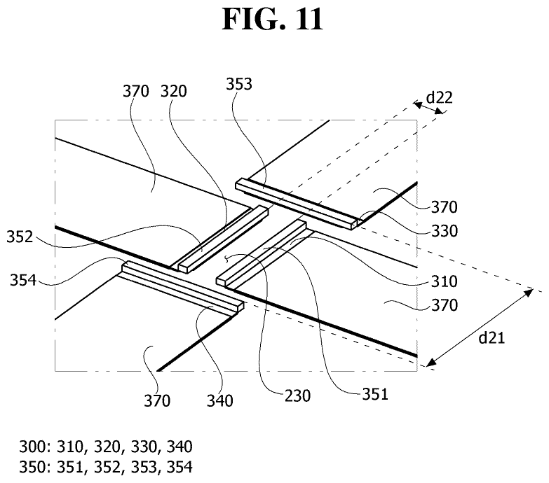

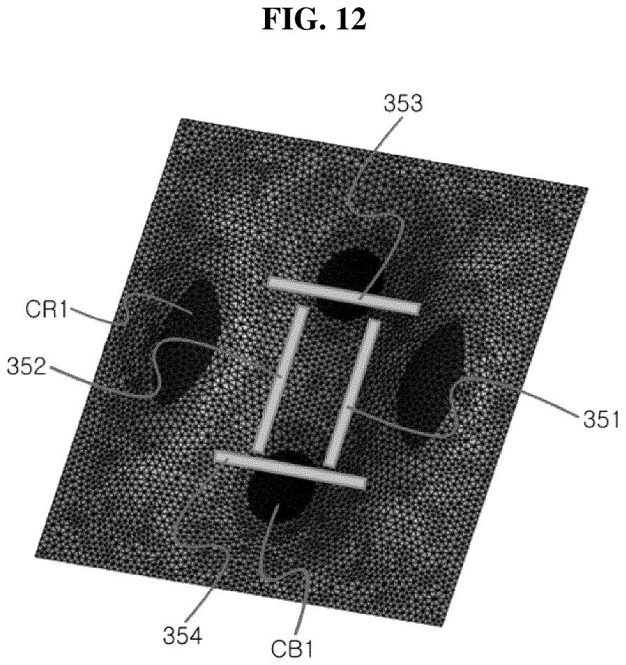

FIG. 10 is a perspective view showing an apparatus according to a second embodiment of the present specification. FIG. 11 is an enlarged view of a portion of FIG. 10 according to one embodiment of the present specification. FIG. 12 is a view showing a state in which a plurality of transmission members and the vibration member are disposed according to one embodiment of the present specification.

Referring to FIGS. 10 and 11, the housing 100 may have a quadrangular shape, but is not necessarily limited thereto. The shape of the housing 100 may be a polygonal shape such as a triangle or hexagonal shape, a circular or elliptical shape, and a curved shape having various curvatures.

The housing 100 may have a rectangular shape in which a length W2 in the first direction (X-axis direction) differs from a length W1 in the second direction (Y-axis direction). The vibration member 200 disposed on the housing 100 may also have a rectangular shape corresponding to the shape of the housing 100, but the embodiments of the present specification are not limited thereto. The resonance mode shape of the vibration member 200, which has a rectangular shape, may be different from a square shape. Therefore, in order to suppress the local mode generated in the rectangular-shaped vibration member 200, the positions at which the plurality of first transmission members 350 come into contact with the vibration member 200 may be changed.

The plurality of first sub-plates 300 may have a predetermined length from the edge of the housing 100 to the central portion 230. The plurality of first sub-plates 300 may have one sides connected or fixed to the housing 100 and the other sides connected or fixed to the vibration member 200. The plurality of first sub-plates 300 may be disposed to be spaced apart from each other so as not to overlap each other in a plan view.

The number of plurality of first sub-plates 300 is not particularly limited. For example, the number of plurality of first sub-plates 300 may be changed variously such as 2, 4, or 6. Hereinafter, although an example in which four sub-plates are disposed will be described, the embodiments of the present specification are not limited thereto.

The plurality of first sub-plates 300 may include the first-first sub-plate 310 and the first-second sub-plate 320 facing each other in the first direction (X-axis direction), and the first-third sub-plate 330 and the first-fourth sub-plate 340 facing each other in the second direction (Y-axis direction) intersecting the first direction. The first direction and the second direction may be perpendicular, but may intersect at an angle rather than a right angle.

The first vibration element 370 may be disposed on each of the first-first to first-fourth sub-plates 310, 320, 330, and 340. The first vibration element 370 may be disposed on one surfaces and/or the other surfaces of the first-first to first-fourth sub-plates 310, 320, 330, and 340.

When power is applied to the first vibration elements 370 disposed on the first-first to first-fourth sub-plates 310, 320, 330, and 340, the first-first to first-fourth sub-plates 310, 320, 330, and 340 may vibrate. Since the one sides of the first to fourth sub-plates 310, 320, 330, and 340 are connected or fixed to the housing 100, the other sides of the first to fourth sub-plates 310, 320, 330, and 340 may vibrate vertically to transmit the exciting forces to the vibration member 200.

Lengths of the first-first to first-fourth sub-plates 310, 320, 330, and 340 may be the same. Therefore, the first-first to first-fourth sub-plates 310, 320, 330, and 340 may transmit vibrations in the same sound band to the vibration member 200.

A first spacing d22 between the first-first sub-plate 310 and the first-second sub-plate 320 may differ from a second spacing d21 between the first-third sub-plate 330 and the first-fourth sub-plate 340.

The first spacing d22 may be narrower than the second spacing d21. For example, the first-first sub-plate 310 and the first-second sub-plate 320 may extend between the first-third sub-plate 330 and the first-fourth sub-plate 340. For example, the other sides of the first-third sub-plate 330 and the first-fourth sub-plate 340 may be disposed to face side surfaces of the first-first sub-plate 310 and the first-second sub-plate 320.

The other side of the first-first sub-plate 310 may be attached to one surface of the vibration member 200 by the first-first transmission member 351. The other sides of the first-second to first-fourth sub-plates 320, 330 and 340 may be attached to the one surface of the vibration member 200 by the first-second to first-fourth transmission members 352, 353, and 354, respectively.

A gap between the first-first transmission member 351 and the first-second transmission member 352 may differ from a gap between the first-third transmission member 353 and the first-fourth transmission member 354.

Referring to FIG. 12, the vibration member 200 may have the tertiary resonance mode in which the blue concave portion CB1 and the red convex portion CR1 are formed. Green and yellow portions between the blue and red may be curved portions connecting the concave portion CB1 to the convex portion CR1. The first-first to first-fourth transmission members 351, 352, 353, and 354 may be disposed between two concave portions CB1 and/or between a plurality of convex portions CR1 to suppress the local modes occurring in the rectangular-shaped vibration member 200. Therefore, the local mode of the vibration member 200 may be reduced and the primary vibration mode may be amplified, thereby improving a sound pressure level (SPL).

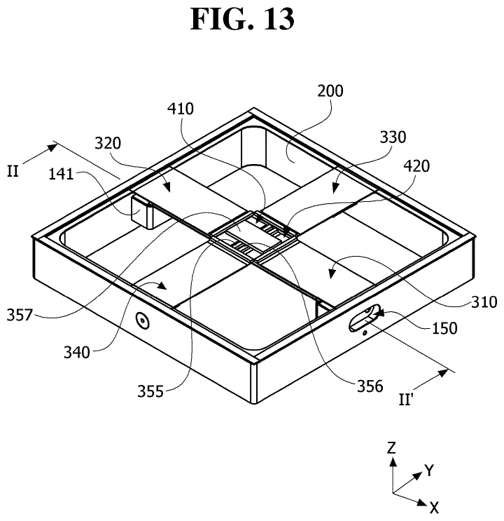

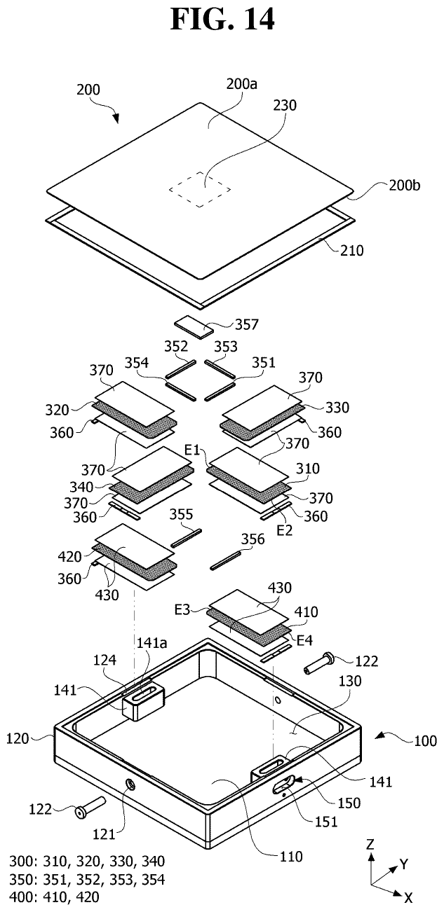

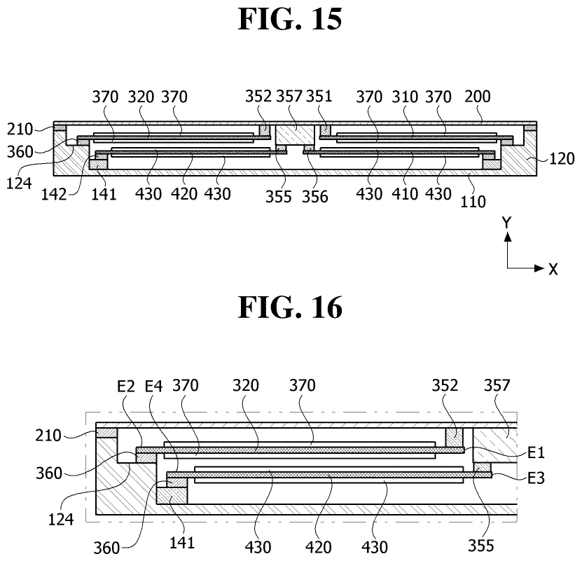

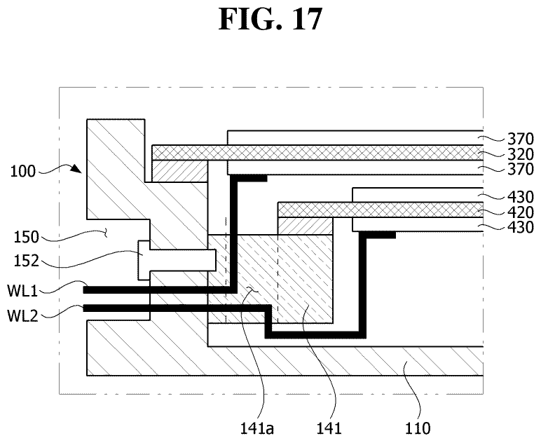

FIG. 13 is a perspective view showing an apparatus according to a third embodiment of the present specification. FIG. 14 is an exploded perspective view of FIG. 13 according to one embodiment of the present specification. FIG. 15 is a cross-sectional view along line II-II′ in FIG. 13 according to one embodiment of the present specification. FIG. 16 is an enlarged view of a portion of FIG. 15 according to one embodiment of the present specification. FIG. 17 is a diagram showing a state in which a power source is connected to a vibration element according to the third embodiment of the present specification.

Referring to FIGS. 13 to 16, the apparatus according to the embodiment may include a housing 100, a plurality of first sub-plates 300, a plurality of second sub-plates 400, and a vibration member 200.

The housing 100 may include an internal space 130. The housing 100 may include a bottom portion 110 and a side wall portion 120 surrounding the bottom portion 110. The bottom portion 110 and the side wall portion 120 may be formed integrally, but are not necessarily limited thereto. For example, the bottom portion 110 and the side wall portion 120 may be assembled by being formed separately. The bottom portion 110 and the side wall portion 120 may be made of the same material or different materials.

The housing 100 may include the internal space 130 surrounded by the bottom portion 110 and the side wall portion 120. The internal space 130 may be an empty space in the housing 100. When the bottom portion 110 and the side wall portion 120 of the housing 100 are formed integrally, the internal space 130 may be a groove formed in the housing 100.

According to an embodiment, the housing 100 may have a quadrangular shape, but is not necessarily limited thereto. The shape of the housing 100 may be a polygonal shape such as a triangle or hexagonal shape, a circular or elliptical shape, and a curved shape having various curvatures.

The vibration member 200 may be disposed on the housing 100. The vibration member 200 may be disposed on the internal space 130. The vibration member 200 may be connected or fixed to the housing 100 by a first coupling member 210 disposed at an upper edge of the housing 100. The first coupling member 210 may be an adhesive tape, but is not necessarily limited thereto, and any adhesive material may be applied in any way.

The plurality of first sub-plates 300 may be disposed in the internal space 130 of the housing 100 to transmit vibrations to the vibration member 200. In the apparatus according to the embodiment of the present specification, the vibration member 200 may vibrate by vibrations generated from the plurality of first sub-plates 300 without directly vibrating by the vibration element.

The plurality of first sub-plates 300 may have a predetermined length from an edge of the housing 100 to the center. The plurality of first sub-plates 300 may include an elastic metallic material or a non-metallic material (or a composite non-metallic material), but the embodiments of the present specification are not limited thereto.

The plurality of first sub-plates 300 may have one sides E2 connected or fixed to the housing 100 and the other sides E1 connected or fixed to a second surface 200b of the vibration member 200. The plurality of first sub-plates 300 may be disposed to be spaced apart from each other so as not to overlap each other. For example, the plurality of first sub-plates 300 may be disposed to be spaced apart from each other so as not to overlap each other in a plan view.

The one side E2 of each of the plurality of first sub-plates 300 may be connected or fixed to each of a plurality of stepped portions 124 formed on the side wall portion 120 of the housing 100. A second coupling member 360 may be disposed between the stepped portions 124 and the plurality of first sub-plates 300. The second coupling member 360 may be made of a plastic material, but the embodiments of the present specification are not limited thereto. The second coupling member 360 may be made of a polycarbonate material, a polyurethane material, a polyolefin material, or a styrene material, but the embodiments of the present specification are not limited thereto. The styrene material may be an ABS material. The ABS material may be acrylonitrile, butadiene, and styrene. For example, the second coupling member 360 may include one or more of an adhesive, a double-sided tape, a double-sided foam tape, a double-sided foam pad, and a double-sided cushion tape, but the embodiments of the present specification are not limited thereto.

The other sides E1 of the plurality of first sub-plates 300 may be attached to the second surface 200b of the vibration member 200 by a plurality of first transmission members 350. The first transmission member 350 may be made of any material capable of transmitting the vibrations of the plurality of first sub-plates 300 to the vibration member 200. For example, the plurality of first transmission members 350 may be made of a material such as polycarbonate (PC), but are not necessarily limited thereto.

The number of plurality of first sub-plates 300 is not particularly limited. For example, the number of plurality of first sub-plates 300 may be changed variously such as 2, 4, or 6. Hereinafter, although an example in which four sub-plates are disposed will be described, the embodiments of the present specification are not limited thereto.

The plurality of first sub-plates 300 may include a first-first sub-plate 310 and a first-second sub-plate 320 facing each other in the first direction (X-axis direction), and a first-third sub-plate 330 and a first-fourth sub-plate 340 facing each other in the second direction (Y-axis direction). The first direction and the second direction may be perpendicular, but may intersect at an angle rather than a right angle.

The first vibration element 370 may be disposed on each of the first-first to first-fourth sub-plates 310, 320, 330, and 340. The first vibration element 370 may be disposed on one surfaces and/or the other surfaces of the first-first to first-fourth sub-plates 310, 320, 330, and 340.

When power is applied to the first vibration elements 370 disposed on the first-first to first-fourth sub-plates 310, 320, 330, and 340, the first-first to first-fourth sub-plates 310, 320, 330, and 340 may vibrate. Since the one sides E2 of the first-first to first-fourth sub-plates 310, 320, 330, and 340 are connected or fixed to the housing 100, the other sides E1 of the first-first to first-fourth sub-plates 310, 320, 330, and 340 vibrate vertically, and exciting forces may be transmitted to the vibration member 200.

Lengths of the first-first to first-fourth sub-plates 310, 320, 330, and 340 may be the same. Therefore, the first-first to first-fourth sub-plates 310, 320, 330, and 340 may generate vibrations in the same sound band. The vibration member 200 may generate acoustic waves (sound pressure) according to the vibrations of the first-first to first-fourth sub-plates 310, 320, 330, and 340.

A first spacing between the first-first sub-plate 310 and the first-second sub-plate 320 may be the same as a second spacing between the first-third sub-plate 330 and the first-fourth sub-plate 340.

A plurality of second sub-plates 400 may be disposed under the plurality of first sub-plates 300. However, the embodiments of the present specification are not limited thereto. For example, the plurality of second sub-plates 400 may be disposed above the plurality of first sub-plates 300.

The plurality of second sub-plates 400 may have a predetermined length from the edge of the housing 100 to the center. The plurality of second sub-plates 400 may have one sides E4 connected or fixed to the housing 100 and the other sides E3 connected or fixed to the vibration member 200. The plurality of second sub-plates 400 may be disposed to be spaced apart from each other so as not to overlap each other. For example, the plurality of second sub-plates 400 may be disposed to be spaced apart from each other so as not to overlap each other in a plan view.

The one sides E4 of the plurality of second sub-plates 400 may be connected or fixed to a protruding member 141 disposed on the side wall portion 120 of the housing 100. The protruding member 141 may be connected or fixed to the side wall portion 120 or the bottom portion 110 of the housing 100. The protruding member 141 may be disposed closer to the center of the housing 100 than the stepped portion 124, but the embodiments of the present specification are not limited thereto. A second coupling member 360 may be disposed between the protruding member 141 and the second sub-plate 400. The second coupling member 360 may be formed of an adhesive tape of any material.

The other sides E3 of the plurality of second sub-plates 400 may be attached to the second surface 200b of the vibration member 200 by second transmission members 355 and 356. The second transmission members 355 and 356 may have the same material as the first transmission member 350, but the embodiments of the present specification are not limited thereto.

The second transmission members 355 and 356 may be connected to a central member 357 disposed at the center of the second surface 200b of the vibration member 200. The plurality of first transmission members 350 may be disposed to surround the plurality of second transmission members 355 and 356. The central member 357 may have the same material as the second transmission members 355 and 356, but the embodiment of the present specification is not limited thereto. The central member 357 may have a different material from the second transmission members 355 and 356. The plurality of second sub-plates 400 may transmit exciting forces to the vibration member 200 through the second transmission members 355 and 356 and the central member 357.

For another example, the central member 357 may be a weight member. The central member 357 may be made of a medium or high hardness material or a metallic material, but the embodiments of the present specification are not limited thereto.

The number of plurality of second sub-plates 400 is not particularly limited. For example, the number of plurality of second sub-plates 400 may be smaller than the number of plurality of first sub-plates 300. For example, the number of plurality of second sub-plates 400 may be 2. However, the embodiments of the present specification are not limited thereto. The number of plurality of second sub-plates 400 may be changed variously such as 4, 6, or 8. In addition, other sub-plates may be further disposed under the plurality of second sub-plates 400.

The plurality of second sub-plates 400 may include a second-first sub-plate 410 and a second-second sub-plate 420 facing each other in the first direction (X-axis direction). The second-first sub-plate 410 may be disposed to overlap the first-first sub-plate 310, and the second-second sub-plate 420 may be disposed to overlap the first-second sub-plate 320.

A third vibration element 430 may be disposed on each of the second-first and second-second sub-plates 410 and 420. The third vibration element 430 may be disposed on one surfaces and/or the other surfaces of the second-first and second-second sub-plates 410 and 420.

When power is applied to the third vibration elements 430 disposed on the second-first and second-second sub-plates 410 and 420, the second-first and second-second sub-plates 410 and 420 may vibrate. Since one sides E4 of the second-first and second-second sub-plates 410 and 420 are connected or fixed to the protruding member 141, the other sides E3 of the second-first and second-second sub-plates 410 and 420 may vibrate vertically to transmit vibrations to the vibration member 200. The first-first to first-fourth sub-plates 310, 320, 330, and 340 and the second-first and second-second sub-plates 410 and 420 may have a cantilever structure.

Lengths of the second-first and second-second sub-plates 410 and 420 may be the same. Therefore, vibrations in the same sound band of the second-first and second-second sub-plates 410 and 420 may be generated. The vibration member 200 may output acoustic waves according to the vibrations of the first-first to first-fourth sub-plates 310, 320, 330, and 340 and the second-first and second-second sub-plates 410 and 420.

The lengths of the plurality of first sub-plates 300 may differ from the lengths of the plurality of second sub-plates 400. For example, the lengths of the plurality of first sub-plates 300 may be formed to be shorter than the lengths of the plurality of second sub-plates 400. In this case, the plurality of relatively short first sub-plates 300 may generate sound pressures in a high sound band, and the plurality of relatively long second sub-plates 400 may generate sound pressures in a low sound band. However, the embodiments of the present specification are not limited thereto.

For example, the lengths of the plurality of first sub-plates 300 may be formed to be longer than the lengths of the plurality of second sub-plates 400. The plurality of relatively long first sub-plates 300 may generate sound pressures in a low sound band, and the plurality of relatively short second sub-plates 400 may generate sound pressures in a high sound band.

For example, the lengths of the plurality of first sub-plates 300 may be formed to lengths capable of covering the entire bands, but the embodiments of the present specification are not limited thereto. The lengths of the plurality of second sub-plates 400 may improve a sound pressure in a specific band.

The lengths of the plurality of first sub-plates 300 may be the same as the lengths of the plurality of second sub-plates 400. For example, the second sub-plate 400 may protrude further to the center than the first sub-plate 300 as much as the protruding member 141 protruding to the center of the housing 100.

According to an embodiment, the acoustic waves may be generated in any band of sound by adjusting the lengths of the plurality of first sub-plates 300 and second sub-plates 400, which may supplement a relatively insufficient band of sound. In addition, the resonance frequency of the vibration member 200 may be adjusted in various ways.

In a plan view, the central member 357, the second-first transmission member 356, and the second-second transmission member 355 may be disposed to be surrounded by the first-first transmission member to the first-fourth transmission member 351, 352, 353, and 354.

According to an embodiment, the central portion 230 of the vibration member 200 where the primary vibration and local modes are concentrated, causes the plurality of first sub-plates 300 and second sub-plates 400 to vibrate in any direction so that a flat plate with a large area behaves up and down, thereby improving the primary vibration mode. For example, the vibrations transmitted by the second-second transmission member 355 may generate a higher amplitude at the central portion 230, thereby widening the vibration area of the vibration member 200.

Referring to FIG. 17, the protruding member 141 may be disposed in a region corresponding to a groove 150 disposed in the side surface of the housing 100. The protruding member 141 may be connected or fixed to the housing 100 by a fastening member 152. The protruding member 141 may be disposed to be spaced apart from the bottom surface 110 of the housing. A first wire WL1 may be inserted (or accommodated) through the hole of the housing 100 and electrically connected to the first vibration element 370 through a first through hole 141a of the protruding member 141. In addition, a second wire WL2 may be electrically connected to the third vibration element 430. However, the embodiments of the present specification are not limited thereto. The first vibration element 370, the second vibration element 220, and the third vibration element 430 may be connected to an external power supply by any connection structure. The first wire WL1 and the second wire WL2 may be electrically connected so that the same negative voltage and positive voltage may be applied to the vibration elements of the apparatus. Therefore, it is possible to reduce the interference between the first to third vibration elements 370, 220, and 430 due to a phase difference.

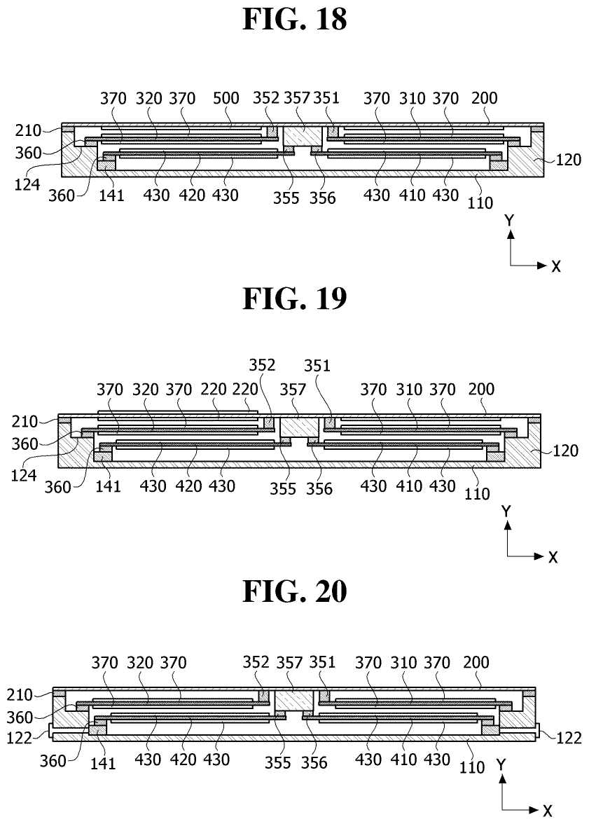

FIGS. 18 to 20 are views showing an apparatus according to an embodiment of the present specification. FIG. 18 is a diagram showing the arrangement of a vibration member and a weight member according to one embodiment of the present specification. FIG. 19 is a diagram showing the arrangement of the vibration member and a vibration element according to one embodiment of the present specification. FIG. 20 is a diagram showing the arrangement of a housing and a duct according to one embodiment of the present specification.

Referring to FIG. 18, a weight member 500 may be disposed between the vibration member 200 and a plurality of first sub-plates 300. Since the vibrations of the plurality of first sub-plates 300 is transmitted to the vibration member 200 in the embodiment, the resonance frequency may be adjusted by adjusting the stiffness and weight of the vibration member 200 that vibrates by the plurality of first sub-plates 300. Therefore, since the number of factors capable of adjusting the resonance frequency of the vibration member 200 increases, the resonance frequency of the vibration member 200 may be optimized.

Since the local mode may be formed in regions between the vibration member 200 and the plurality of first sub-plates 300, the weight members 500 may be disposed between the vibration member 200 and the plurality of first sub-plates 300 to increase the mass of the vibration member 200, thereby suppressing the local mode.

The weight member 500 may be disposed in all regions in which the vibration member 200 overlaps the plurality of first sub-plates 300, but the embodiments of the present specification are not limited thereto. The weight member 500 may be disposed in some regions in which the vibration member 200 overlaps the plurality of second sub-plates 400, but the embodiments of the present specification are not limited thereto. In addition, the weight member 500 may be disposed in regions in which the vibration member 200 does not overlap the plurality of first sub-plates 300 and second sub-plates 400, but the embodiments of the present specification are not limited thereto.

Referring to FIG. 19, the second vibration element 220 may be attached to the vibration member 200. For example, the second vibration element 220 may be directly attached to the vibration member 200. When power is applied to the second vibration element 220, the vibration member 200 may output acoustic waves according to vibrations. When the first vibration element 370, the second vibration element 220, and the third vibration element 430 vibrate together, the self-vibrations of the vibration member 200 by the second vibration element 220 and the vibrations transmitted by the first and second sub-plates 300 and 400 may be synthesized.

According to the embodiment of the present specification, there is an advantage that the sound pressure in the low sound band and the medium/high sound bands may be improved simultaneously by mixing the direct attachment structure and the cantilever structure.

Referring to FIG. 20, it is possible to improve sound performance by arranging a duct 122 and/or a vent hole (or a hole) 121 in the housing 100. The duct 122 may be inserted into (or accommodated in) the hole or the vent hole 121 formed in the side wall portion 120 of the housing 100. Therefore, the internal space of the apparatus or the internal space 130 provided between the vibration member 200 and the housing 100 may be connected to or may communicate with an external part by the duct 122 and/or the vent hole (or the hole) 121, thereby reducing the air pressure of the internal space 130. Two ducts 122 and/or vent holes (or holes) 121 may be disposed to face each other, but are not limited thereto. The duct 122 may be an elastic pad having a hole formed therein, but the embodiments of the present specification are not limited thereto.

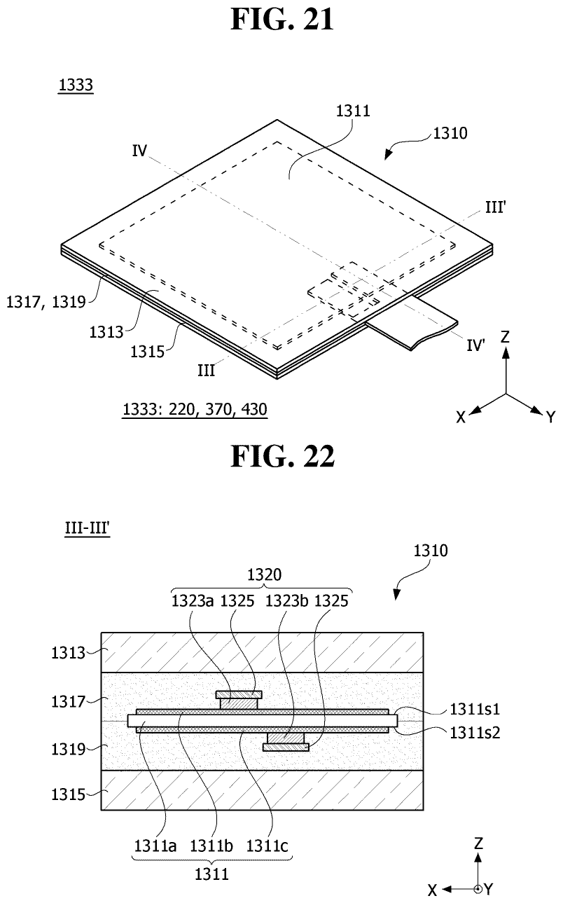

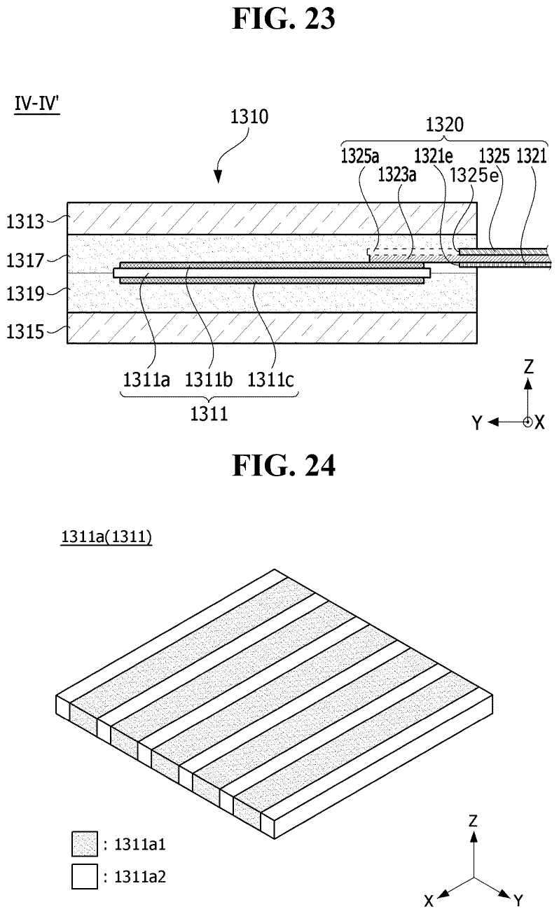

FIG. 21 is a diagram showing a vibration device according to one embodiment of the present specification. FIG. 22 is a cross-sectional view along line III-III′ in FIG. 21 according to one embodiment of the present specification. FIG. 23 is a cross-sectional view along line IV-IV′ in FIG. 21 according to one embodiment of the present specification.

Referring to FIGS. 21 to 23, a vibration device 1333 according to one embodiment of the present specification may include one or more vibration generators 1310. The vibration elements 220, 370, or 430 may be formed as the vibration device 1333. The vibration device and the vibration element may be used interchangeably.

The vibration generator 1310 may include a piezoelectric material having piezoelectric properties. The vibration generator 1310 may vibrate (or displace or drive) the vibration member according to the vibrations (or displacement or driving) of the piezoelectric material according to an electric signal (or a voice signal or acoustic signal) applied to the piezoelectric material. For example, the vibration generator 1310 may vibrate (or displace or drive) by alternately repeating shrinkage and/or expansion by the piezoelectric effect (or piezoelectric properties). For example, the vibration generator 1310 may vibrate (or displace or drive) in a vertical direction (or thickness direction) (Z) by alternately repeating shrinkage and/or expansion by the reverse piezoelectric effect. For example, the vibration generator 1310 may vibrate or mechanically displace (or vibrate or drive) the piezoelectric material including a piezoelectric ceramic in response to an electric signal applied from the outside.

The vibration generator 1310 may be made of a ceramic-based piezoelectric material that may implement relatively strong vibrations or a piezoelectric ceramic having a perovskite-based crystal structure. For example, the vibration generator 1310 may be a vibration generating element, a vibration film, a vibration generating film, a vibrator, an active vibrator, an active vibration generator, an actuator, an exciter, a film actuator, a film exciter, an ultrasonic actuator, or an active vibration member, but the embodiments of the present specification are not limited thereto.

The vibration generator 1310 according to one embodiment of the present specification may include a vibration generating part 1311.

The vibration generating part 1311 may be formed to vibrate by the piezoelectric effect according to a driving signal. For example, the vibration generating part 1311 may include a piezoelectric vibration part. The vibration generating part 1311 may include at least one of a piezoelectric inorganic material and a piezoelectric organic material. For example, the vibration generating part 1311 may be a piezoelectric element, a piezoelectric element part, a piezoelectric element layer, a piezoelectric structure, a piezoelectric vibration part, or a piezoelectric vibrating layer, but the embodiments of the present specification are not limited thereto.

The vibration generating part 1311 according to one embodiment of the present specification may include a vibration portion 1311a, a first electrode portion 1311b, and a second electrode portion 1311c.

The vibration portion 1311a may include a piezoelectric material or an electroactive material having the piezoelectric effect. For example, the vibration portion 1311a may be a piezoelectric layer, a piezoelectric material layer, an electroactive layer, a piezoelectric composite layer, a piezoelectric composite, or a piezoelectric ceramic composite, but the embodiments of the present specification are not limited thereto.

The vibration portion 1311a may be formed of a ceramic-based piezoelectric ceramic that may implement relatively strong vibrations or formed of a piezoelectric ceramic having a perovskite-based crystal structure. For example, the vibration portion 1311a may include at least one of PbTiO₃, PbZrO₃, PbZrTiO₃, BaTiO₃, and SrTiO₃, but the embodiments of the present specification are not limited thereto.

The piezoelectric ceramic may be formed as a single crystal ceramic having a single crystal structure or formed of a ceramic material having a polycrystalline structure or a polycrystalline ceramic. The piezoelectric material of the single crystal ceramic may include α-AlPO₄, α-SiO₂, LiNbO₃, Tb₂(MoO₄)₃, Li₂B4O₇, or ZnO, but the embodiments of the present specification are not limited thereto. The piezoelectric material of the polycrystalline ceramic may include a lead zirconate titanate (PZT)-based material including lead (Pb), zirconium (Zr), and titanium (Ti), or a lead zirconate nickel niobate (PZNN)-based material including lead (Pb), zirconium (Zr), nickel (Ni), and niobium (Nb), but the embodiments of the present specification are not limited thereto. For example, the vibration portion 1311a may include at least one of CaTiO₃, BaTiO₃, and SrTiO₃ that do not include lead (Pb), but the embodiments of the present specification are not limited thereto.

The first electrode portion 1311b may be disposed on a first surface (or an upper surface or front surface) 1311s1 of the vibration portion 1311a. The first electrode portion 1311b may have the same size as the vibration portion 1311a or have a smaller size than the vibration portion 1311a, but the embodiments of the present specification are not limited thereto.

The second electrode portion 1311c may be disposed on a second surface (or a lower surface or back surface) 1311s2 that differs from or is opposite to the first surface 1311s1 of the vibration portion 1311a. The second electrode portion 1311c may have the same size as the vibration portion 1311a or have a smaller size than the vibration portion 1311a, but the embodiments of the present specification are not limited thereto. For example, the second electrode portion 1311c may have the same shape as the vibration portion 1311a, but the embodiments of the present specification are not limited thereto.

One or more of the first electrode portion 1311b and the second electrode portion 1311c according to one embodiment of the present specification may be made of a transparent conductive material, a semitransparent conductive material, or an opaque conductive material. For example, the transparent or semitransparent conductive material may include indium tin oxide (ITO) or indium zinc oxide (IZO), but the embodiments of the present specification are not limited thereto. The opaque conductive material may include gold (Au), silver (Ag), platinum (Pt), palladium (Pd), molybdenum (Mo), magnesium (Mg), carbon, or silver (Ag) containing glass frit, or may be made of an alloy thereof, but the embodiments of the present specification are not limited thereto. For example, each of the first electrode portion 1311b and the second electrode portion 1311c may include silver (Ag) having low resistivity to improve the electrical characteristics and/or vibration characteristics of the vibration portion 1311a. For example, carbon may be a carbon material including carbon black, ketjen black, carbon nanotubes, and graphite, but the embodiments of the present specification are not limited thereto.

The vibration portion 1311a may be polarized (or poled) by a constant voltage applied to the first electrode portion 1311b and the second electrode portion 1311c in a constant temperature atmosphere or a temperature atmosphere that changes from a high temperature to room temperature, but the embodiments of the present specification are not limited thereto. For example, a polarization direction (or poling direction) formed in the vibration portion 1311a may be formed or oriented (or arranged) from the first electrode portion 1311b to the second electrode portion 1311c, but is not limited thereto. For example, the polarization direction (or poling direction) formed in the vibration portion 1311a may be formed or oriented (or arranged) from the second electrode portion 1311c to the first electrode portion 1311b.

The vibration portion 1311a may vibrate by alternately repeating shrinkage and/or expansion due to the reverse piezoelectric effect according to the driving signal applied from the outside to the first electrode portion 1311b and the second electrode portion 1311c. For example, the vibration portion 1311a may vibrate in the vertical direction (or thickness direction) and the horizontal direction by the signal applied to the first electrode portion 1311b and the second electrode portion 1311c. The vibration portion 1311a may be displaced (or vibrated or driven) as a result of shrinkage and/or expansion in the horizontal direction, which improves the vibration characteristics including the acoustic characteristics and/or the sound pressure characteristics of the vibration generator 1310.

The vibration generator 1310 according to one embodiment of the present specification may further include a first cover member 1313 and a second cover member 1315.

The first cover member 1313 may be disposed on the first surface of the vibration generating part 1311. For example, the first cover member 1313 may be formed to cover the first electrode portion 1311b of the vibration generating part 1311. For example, the first cover member 1313 may be formed to have a larger size than the vibration generating part 1311, but the embodiments of the present specification are not limited thereto. The first cover member 1313 may be formed to protect the first surface and the first electrode portion 1311b of the vibration generating part 1311.

The second cover member 1315 may be disposed on the second surface of the vibration generating part 1311. For example, the second cover member 1315 may be formed to cover the second electrode portion 1311c of the vibration generating part 1311. For example, the second cover member 1315 may be formed to have a larger size than the vibration generating part 1311 and formed to have the same size as the first cover member 1313, but the embodiments of the present specification are not limited thereto. The second cover member 1315 may be formed to protect the second surface and the second electrode portion 1311c of the vibration generating part 1311.

The first cover member 1313 and the second cover member 1315 according to one embodiment of the present specification may include the same material or different materials. For example, each of the first cover member 1313 and the second cover member 1315 may be a polyimide film, a polyethylene terephthalate film, a polyethylene naphthalate film, or the like, but the embodiments of the present specification are not limited thereto.

The first cover member 1313 may be connected or coupled to the first surface or the first electrode portion 1311b of the vibration generating part 1311 via a first adhesive layer 1317. For example, the first cover member 1313 may be connected or coupled to the first surface or the first electrode portion 1311b of the vibration generating part 1311 by a film laminating process using the first adhesive layer 1317 as a medium.

The second cover member 1315 may be connected or coupled to the second surface or the second electrode portion 1311c of the vibration generating part 1311 via a second adhesive layer 1319. For example, the second cover member 1315 may be connected or coupled to the second surface or the second electrode portion 1311c of the vibration generating part 1311 by a film laminating process using the second adhesive layer 1319 as a medium.

Each of the first adhesive layer 1317 and the second adhesive layer 1319 according to the embodiment of the present specification may include an electrically insulating material that is compressible and restorable while having adhesiveness. For example, each of the first adhesive layer 1317 and the second adhesive layer 1319 may include an epoxy resin, an acrylic resin, a silicone resin, a urethane resin, an acrylic polymer, a silicone polymer, or a urethane polymer, but the embodiments of the present specification are not limited thereto.

The first adhesive layer 1317 and the second adhesive layer 1319 may be formed between the first cover member 1313 and the second cover member 1315 to surround the vibration generating part 1311. For example, one or more of the first adhesive layer 1317 and the second adhesive layer 1319 may be formed to partially or fully surround the vibration generating part 1311.

One of the first cover member 1313 and the second cover member 1315 may be connected or coupled to the vibration member via the adhesive member.

One of the first cover member 1313 and the second cover member 1315 may be omitted. For example, one of the first cover member 1313 and the second cover member 1315 may be formed to cover or protect at least one of the first surface and the second surface of the vibration generator 1310.

The vibration generator 1310 according to one embodiment of the present specification may further include a signal supply member 1320.

The signal supply member 1320 may be formed to supply a driving signal supplied from a driving circuitry to the vibration generation part 1311. The signal supply member 1320 may be formed to be electrically connected to the vibration generating part 1311. The signal supply member 1320 may be formed to be electrically connected to the first electrode portion 1311b and the second electrode portion 1131c of the vibration generating part 1311.

A portion of the signal supply member 1320 may be accommodated (or inserted) between the first cover member 1313 and the second cover member 1315. An end portion (or an end or one side) of the signal supply member 1320 may be disposed or inserted (or accommodated) in a portion between one edge portion of the first cover member 1313 and one edge portion of the second cover member 1315. The one edge portion of the first cover member 1313 and the one edge portion of the second cover member 1315 may accommodate or vertically cover the end portion (or the end or one side) of the signal supply member 1320. As a result, the signal supply member 1320 may be integrated with the vibration generating part 1311. Accordingly, the vibration device 1333 may be implemented in the form of a film integrated with the signal supply member 1320. For example, the signal supply member 1320 may be formed as a single component with the vibration generating part 1311, thereby achieving the uni-materialization effect. For example, the signal supply member 1320 may be formed as a signal cable, a flexible cable, a flexible printed circuit cable, a flexible flat cable, a single-sided flexible printed circuit, a single-sided flexible printed circuit board, a flexible multilayer printed circuit, or a flexible multilayer printed circuit board, but the embodiments of the present specification are not limited thereto.

The signal supply member 1320 according to one embodiment of the present specification may include a base member 1321 and a plurality of signal lines 1323a and 1323b. For example, the signal supply member 1320 may include the base member 1321, a first signal line 1323a, and a second signal line 1323b.

The base member 1321 may include a transparent or opaque plastic material, but the embodiments of the present specification are not limited thereto. The base member 1321 may have a constant width in the first direction (X) and extend in the second direction (Y) intersecting the first direction (X).

The first signal line 1323a and the second signal line 1323b may be disposed on the first surface of the base member 1321 to be parallel to the second direction (Y) and may be spaced apart from each other or electrically separated in the first direction (X). The first signal line 1323a and the second signal line 1323b may be disposed parallel to each other on the first surface of the base member 1321. For example, the first signal line 1323a and the second signal line 1323b may be implemented in a line shape by patterning a metal layer (or a conductive layer) formed or deposited on the first surface of the base member 1321, but the embodiments of the present specification are not limited thereto.

The end portions (or the ends or one sides) of the first signal line 1323a and the second signal line 1323b may be separated and individually bent or curved.

The end portion (or the end or one side) of the first signal line 1323a may be electrically connected to the first electrode portion 1311b of the vibration generating part 1311. For example, the end portion of the first signal line 1323a may be electrically connected to at least a portion of the first electrode portion 1311b of the vibration generating part 1311 at one edge portion of the first cover member 1313. For example, the end portion (or the end or one side) of the first signal line 1323a may be electrically directly connected to at least a portion of the first electrode portion 1311b of the vibration generating part 1311. For example, the end portion (or the end or one side) of the first signal line 1323a may be directly connected to or may directly come into contact with the first electrode portion 1311b of the vibration generating part 1311. For example, the end portion of the first signal line 1323a may be electrically connected to the first electrode portion 1311b by a conductive double-sided tape. Therefore, the first signal line 1323a may supply the first driving signal supplied from the driving circuitry to the first electrode portion 1311b of the vibration generating part 1311.

The end portion (or the end or one side) of the second signal line 1323b may be electrically connected to the second electrode portion 1311c of the vibration generating part 1311. For example, the end portion of the second signal line 1323b may be electrically connected to at least a portion of the second electrode portion 1311c of the vibration generating part 1311 at one edge portion of the second cover member 1315. For example, the end portion of the second signal line 1323b may be electrically directly connected to at least a portion of the second electrode portion 1311c of the vibration generating part 1311. For example, the end portion of the second signal line 1323b may be directly connected to or may directly come into contact with the second electrode portion 1311c of the vibration generating part 1311. For example, the end portion of the second signal line 1323b may be electrically connected to the second electrode portion 1311c through a conductive double-sided tape. Accordingly, the second signal line 1323b may supply the second driving signal supplied from the driving circuitry to the second electrode portion 1311c of the vibration generating part 1311.

The signal supply member 1320 according to one embodiment of the present specification may further include an insulating layer 1325.

The insulating layer 1325 may be disposed on the first surface of the base member 1321 to cover each of the first signal line 1323a and the second signal line 1323b excluding an end portion (or one side) of the signal supply member 1320.

The end portion (or one side) of the signal supply member 1320 including an end portion (or one side) of the base member 1321 and an end portion (or one side) 1325a of the insulating layer 1325 may be inserted (or accommodated) between the first cover member 1313 and the second cover member 1315 and may be fixed (or connected) between the first cover member 1313 and the second cover member 1315 by the first adhesive layer 1317 and the second adhesive layer 1319. This may allow the end portion (or one side) of the first signal line 1323a to be maintained in a state of being electrically connected to the first electrode portion 1311b of the vibration generating part 1311 and may allow the end portion (or one side) of the second signal line 1323b to be maintain in a state of being electrically connected to the second electrode portion 1311c of the vibration generating part 1311. In addition, since the end portion (or one side) of the signal supply member 1320 may be inserted (or accommodated) and fixed (or connected) between the vibration generating part 1311 and the first cover member 1313, it is possible to prevent poor connection between the vibration generating part 1311 and the signal supply member 1320 due to the movement of the signal supply member 1320.

In the signal supply member 1320 according to one embodiment of the present specification, the end portion (or one side) of the base member 1321 and the end portion (or one side) 1325a of the insulating layer 1325 may be removed. For example, the end portion (or one side) of the first signal line 1323a and the end portion (or one side) of the second signal line 1323b may not be supported or covered by and exposed to the outside by the end portion (or one side) of the base member 1321 and the end portion (or one side) 1325a of the insulating layer 1325. For example, the end portion (or one side) of each of the first signal line 1323a and the second signal line 1323b may protrude (or extend) from an end 1321e of the base member 1321 or an end 1325e of the insulating layer 1325 to have a predetermined length. Accordingly, the end portion (or the end or one side) of each of the first signal line 1323a and the second signal line 1323b may be individually or independently bent.

The end portion (or one side) of the first signal line 1323a that is not supported by each of the end portion (or one side) of the base member 1321 and the end portion (or one side) 1325a of the insulating layer 1325 may be directly connected to or may directly come into contact with the first electrode portion 1311b of the vibration generating part 1311. The end portion (or one side) of the second signal line 1323b that is not supported by each of the end portion (or one side) of the base member 1321 and the end portion (or one side) 1325a of the insulating layer 1325 may be directly connected to or may directly come into contact with the second electrode portion 1311c of the vibration generating part 1311.

According to one embodiment of the present specification, a portion of the signal supply member 1320 or a portion of the base member 1321 may be disposed or inserted (or accommodated) between the first cover member 1313 and the second cover member 1315 so that the signal supply member 1320 is integrated with the vibration generating part 1311. Therefore, the vibration generating part 1311 and the signal supply member 1320 may be formed as a single component, thereby achieving the uni-materialization effect.

According to one embodiment of the present specification, since the first signal line 1323a and the second signal line 1323b of the signal supply member 1320 are integrated with the vibration generating part 1311, a soldering process for electrical connection between the vibration generating part 1311 and the signal supply member 1320 is not required, thereby simplifying the structure and manufacturing process of the vibration device 1333 and improving the harmful process.

FIG. 24 is a diagram showing a vibration portion according to another embodiment of the present specification. For example, FIG. 24 shows another embodiment of the vibration portion described with reference to FIGS. 21 to 23.

Referring to FIGS. 22 and 24, the vibration portion 1311a according to another embodiment of the present specification may include a plurality of first portions 1311a1 and a plurality of second portions 1311a2. For example, the plurality of first portions 1311a1 and the plurality of second portions 1311a2 may be alternately and repeatedly disposed in the second direction (Y) (or the first direction (X)).

Each of the plurality of first portions 1311a1 may include an inorganic material having the piezoelectric effect (or piezoelectric properties). For example, each of the plurality of first portions 1311a1 may include at least one of a piezoelectric inorganic material and a piezoelectric organic material. For example, each of the plurality of first portions 1311a1 may be an inorganic portion, an inorganic material portion, a piezoelectric portion, a piezoelectric material portion, or an electrically active portion, but the embodiments of the present specification are not limited thereto.

According to one embodiment of the present specification, each of the plurality of first portions 1311a1 may have a width parallel to the second direction (Y) (or the first direction (X)) and extend in the first direction (X) (or the second direction (Y)). Since each of the plurality of first portions 1311a1 is substantially the same as the vibration portion 1311a described with reference to FIGS. 21 to 23, overlapping descriptions thereof may be omitted or simplified.

Each of the plurality of second portions 1311a2 may be disposed between the plurality of first portions 1311a1. For example, each of the plurality of first portions 1311a1 may be disposed between two adjacent second portions 1311a2 among the plurality of second portions 1311a2. Each of the plurality of second portions 1311a2 may have a width parallel to the second direction (Y) (or the first direction (X)) and extend in the first direction (X) (or the second direction (Y)). A width of the first portion 1311a1 may be the same as or different from a width of the second portion 1311a2. For example, the width of the first portion 1311a1 may be larger than the width of the second portion 1311a2. For example, the first portion 1311a1 and the second portion 1311a2 may include a line shape or a stripe shape having the same size or different sizes, but the embodiments of the present specification are not limited thereto.

Each of the plurality of second portions 1311a2 may be formed to fill a gap between two adjacent first portions 1311a1. Each of the plurality of second portions 1311a2 may be formed to fill the gap between the two adjacent first portions 1311a1 to be connected or adhered to a side surface of an adjacent first portion 1311a1. According to one embodiment of the present specification, the plurality of first portions 1311a1 and the plurality of second portions 1311a2 may be disposed (or arranged) parallel to each other on the same plane (or same layer). Therefore, the vibration portion 1311a may expand to a desired size or length by the side coupling (or connection) of the first portion 1311a1 and the second portion 1311a2.

According to one embodiment of the present specification, each of the plurality of second portions 1311a2 may absorb an impact applied to the first portion 1311a1, thereby increasing the durability of the first portion 1311a1 and providing flexibility to the vibration portion 1311a. Each of the plurality of second portions 1311a2 may include an organic material having soft properties. For example, the plurality of second portions 1311a2 may be one or more of an epoxy-based polymer, an acrylic-based polymer, and a silicone-based polymer, but the embodiments of the present specification are not limited thereto. For example, each of the plurality of second portions 1311a2 may be an organic portion, an organic material portion, an adhesive portion, an elastic portion, a bending portion, a damping portion, or a soft portion, but the embodiments of the present specification are not limited thereto.

The first surfaces of the plurality of first portions 1311a1 and the plurality of second portions 1311a2 may be commonly connected to the first electrode portion 1311b. The second surfaces of the plurality of first portions 1311a1 and the plurality of second portions 1311a2 may be commonly connected to the second electrode portion 1311c. For example, one or both of the first electrode portion 1311b and the second electrode portion 1311c may be formed as a pattern-shaped electrode corresponding only to the plurality of first portions 1311a1.

The vibration portion 1311a according to another embodiment of the present specification may have a shape of a single thin film by having the plurality of first portions 1311a1 and the plurality of second portions 1311a2 disposed (or connected) on the same plane. Therefore, the vibration generating part 1311 or the vibration generator 1310 including the vibration portion 1311a according to another embodiment of the present specification may vibrate by the first portion 1311a1 having vibration characteristics and may be bent in a curved shape by the second portion 1311a2 having flexibility.

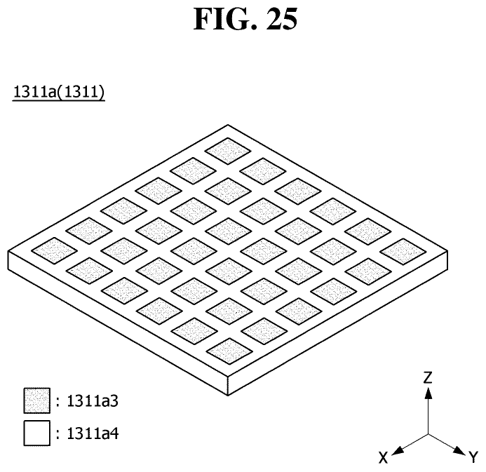

FIG. 25 is a diagram showing a vibration portion according to still another embodiment of the present specification. For example, FIG. 25 shows still another embodiment of the vibration portion described with reference to FIGS. 21 to 23.

Referring to FIG. 22 and FIG. 25, the vibration portion 1311a according to still another embodiment of the present specification may include a plurality of first portions 1311a3, and a second portion 1311a4 disposed between the plurality of first portions 1311a3.

Each of the plurality of first portions 1311a3 may be disposed to be spaced apart from each other in each of the first direction (X) and the second direction (Y). For example, each of the plurality of first portions 1311a3 may have a hexahedral shape having the same size and may be disposed in a grid shape, but the embodiments of the present specification are not limited thereto. For example, each of the plurality of first portions 1311a3 may have a circular plate, an oval plate, or a polygonal plate shape having the same size, but the embodiments of the present specification are not limited thereto.

Since each of the plurality of first portions 1311a3 is substantially the same as the first portion 1311a1 described with reference to FIG. 24, overlapping descriptions thereof may be omitted or simplified.

The second portion 1311a4 may be disposed between the plurality of first portions 1311a3 in each of the first direction (X) and the second direction (Y). The second portion 1311a4 may be formed to fill a gap between two adjacent first portions 1311a3, to be adjacent to each of the plurality of first portions 1311a3, or to surround each of the plurality of first portions 1311a3 to be connected or adhered to an adjacent first portion 1311a3. Since the second portion 1311a4 is substantially the same as the second portion 1311a2 described with reference to FIG. 24, overlapping descriptions thereof may be omitted or simplified.

First surfaces of the plurality of first portions 1311a3 and the second portion 1311a4 may be commonly connected to the first electrode portion 1311b. Second surfaces of the plurality of first portions 1311a3 and the second portion 1311a4 may be commonly connected to the second electrode portion 1311c. According to another embodiment of the present specification, one or more of the first electrode portion 1311b and the second electrode portion 1311c may be formed in a pattern electrode shape corresponding only to the plurality of first portions 1311a3.

The vibration portion 1311a according to still another embodiment of the present specification may have a shape of a single thin film by having the plurality of first portions 1311a3 and the plurality of second portions 1311a4 disposed (or connected) on the same plane. Therefore, the vibration generating part 1311 or the vibration generator 1310 including the vibration portion 1311a according to another embodiment of the present specification may vibrate by the first portion 1311a3 having vibration characteristics and may be bent in a curved shape by the second portion 1311a4 having flexibility.

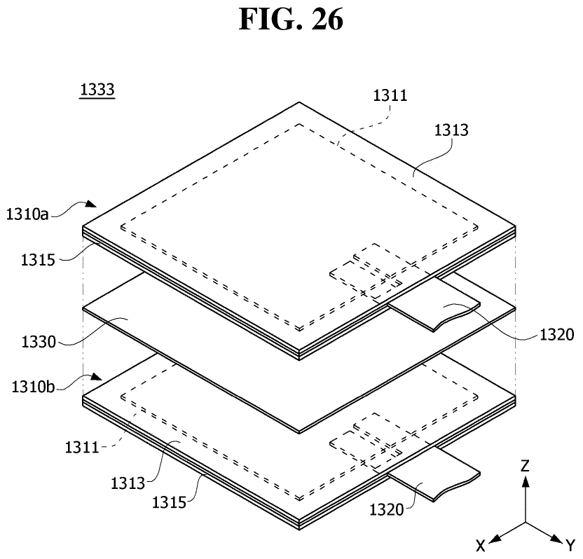

FIG. 26 is a diagram showing a vibration device according to another embodiment of the present specification.

Referring to FIG. 26, a vibration device 1333 according to another embodiment of the present specification may include a plurality of vibration generators 1310a and 1310b. The vibration device 1333 may include a plurality of vibration generators 1310a and 1310b. For example, the vibration device 1333 may include a first vibration generator 1310a and a second vibration generator 1310b.

The first vibration generator 1310a and the second vibration generator 1310b may overlap or may be stacked to displace (or drive or vibrate) in the same direction in order to maximize the amplitude displacement of the vibration device 1333 and/or the amplitude displacement of the vibration member. For example, the first vibration generator 1310a and the second vibration generator 1310b may have substantially the same size, but the embodiments of the present disclosure are not limited thereto. Therefore, the first vibration generator 1310a and the second vibration generator 1310b may maximize the amplitude displacement of the vibration device 1333 and/or the amplitude displacement of the vibration member.

According to one embodiment of the present disclosure, one of the first vibration generator 1310a and the second vibration generator 1310b may be connected or coupled to the vibration member via an adhesive member. For example, the first vibration generator 1310a may be connected or coupled to the vibration member via the adhesive member.

Each of the first vibration generator 1310a and the second vibration generator 1310b is the same as or substantially the same as the vibration generator 1310 described with reference to FIGS. 21 to 25 and thus is denoted by the same reference numerals, and overlapping descriptions thereof may be omitted or simplified.

The vibration device 1333 according to still another embodiment of the present specification may further include an intermediate member 1330.

The intermediate member 1330 may be disposed or connected between the first vibration generator 1310a and the second vibration generator 1310b. For example, the intermediate member 1330 may be disposed or connected between the second cover member 1315 of the first vibration generator 1310a and the first cover member 1313 of the second vibration generator 1310b. For example, the intermediate member 1330 may be an adhesive member or a connection member, but the embodiments of the present specification are not limited thereto.

The intermediate member 1330 according to the embodiment of the present specification may be made of a material including an adhesive layer having excellent sticking strength or adhesive strength to each of the first vibration generator 1310a and the second vibration generator 1310b. For example, the intermediate member 1330 may include a foam pad, a double-sided tape, a double-sided foam tape, a double-sided pad, a double-sided foam pad, an adhesive, or the like, but the embodiments of the present specification are not limited thereto. For example, an adhesive layer of the intermediate member 1330 may include an epoxy, acrylic, silicone, or urethane, but the embodiments of the present specification are not limited thereto. For example, the adhesive layer of the intermediate member 1330 may include a urethane-based material (or material) having relatively soft properties. Therefore, the vibration loss due to the displacement interference between the first vibration generator 1310a and the second vibration generator 1310b may be minimized, or each of the first vibration generator 1310a and the second vibration generator 1310b may freely displace (or vibrate or drive).

The vibration device 1333 according to still another embodiment of the present specification may maximize or increase the displacement or amplitude displacement by including the first vibration generator 1310a and the second vibration generator 1310b that are stacked (or overlapped or superimposed) to vibrate (or displace or drive) in the same direction. Therefore, it is possible to maximize or increase the displacement (or a bending force or driving force) or amplitude displacement of the vibration member.

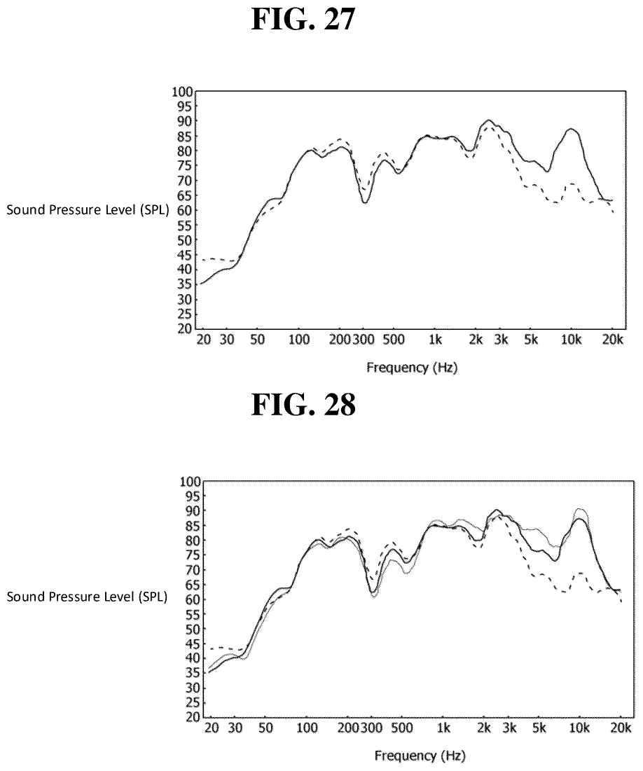

FIGS. 27 to 29 are views showing the sound output characteristics according to an embodiment of the present specification. In FIGS. 27 and 28, the horizontal axis represents a frequency (Hz), and the vertical axis represents a sound pressure (sound pressure level (SPL), dB).

The acoustic output characteristics of the apparatus may be measured by a sound analysis apparatus. The acoustic analysis apparatus may be composed of an input/output module for transmitting and receiving sound with a control PC, an amplifier for amplifying and transmitting sound generated from the output module to a vibration device, and a microphone for collecting acoustic signals generated from the apparatus according to the operation of a vibration element. The acoustic signals collected by the microphone is input to the control PC through the input module and is checked in a control program to analyze a peak response speed of the apparatus.

The acoustic output characteristics were measured in a half anechoic room. During measurement, an input voltage was 10 V, an applied frequency signal was a sine sweep from 20 Hz to 20 kHz, and the measurement results were subjected to ⅓ octave smoothing. A separation distance between the apparatus and the microphone was set to 100 cm. The measurement method is not limited to this example.

Referring to FIG. 27, the solid line represents the acoustic output characteristic of the apparatus in which a material of a central member has medium hardness. The dotted line represents the acoustic output characteristic of the apparatus in which the material of the central member is made of a soft material. The solid line represents an example in which the material of the central member is a polycarbonate (PC) material with medium hardness. The dotted line represents an example in which the material of the central member is formed of a soft foam tape. For example, it can be seen that the solid line has the sound pressure that decreases by about 5 dB in a low sound band of 300 Hz or lower compared to the dotted line. For example, it can be seen that the solid line has the sound pressure that increases by about 13 dB in a high sound band of 5 kHz or higher compared to the dotted line. Since the solid line is made of a material that has the hardness of the material of the central member or relatively high harness compared to the dotted line, it can be confirmed that the sound pressure in the low sound band decreases and the sound pressure in the high sound band greatly increases.

Referring to FIG. 28, the horizontal axis represents frequency (Hz) and the vertical axis represents a sound pressure (SPL, dB). The thin solid line represents the acoustic output characteristics of the apparatus in which the second coupling member has high hardness and the central member has medium hardness. For example, the thin solid line represents an example in which the second coupling member is made of polycarbonate and the central member is made of polycarbonate. The thick solid line represents the acoustic output characteristics of the apparatus in which the second coupling member has low hardness and the central member has medium hardness. For example, the thick solid line represents an example in which the second coupling member is formed of a foam tape and the central member is made of polycarbonate. The dotted line represents the sound output characteristics of the apparatus in which both the second coupling member and the central member have low hardness. For example, the dotted line represents an example in which the second coupling member is formed of a foam tape and the central member is formed of a foam tape.

It can be seen that the thin and thick solid lines show that the sound pressures increase in the high sound band compared to the dotted line. For example, it can be seen that the thin solid line shows the sound pressure that increases by about 20 dB at 3 kHz or higher compared to the dotted line. For example, it can be seen that the thick solid line shows the sound pressure that increases by about 17 dB in the high sound band of 3 kHz or higher compared to the dotted line.

When both the central member 357 and the second coupling member are formed of a soft foam tape, it can be seen that the sound pressure in the high sound band decreases as shown in the dotted line. When the central member 357 is formed of polycarbonate with medium hardness and the second coupling member is made of a material with high hardness, it can be confirmed that the sound pressure in the high sound band increases as shown in the thin solid line.

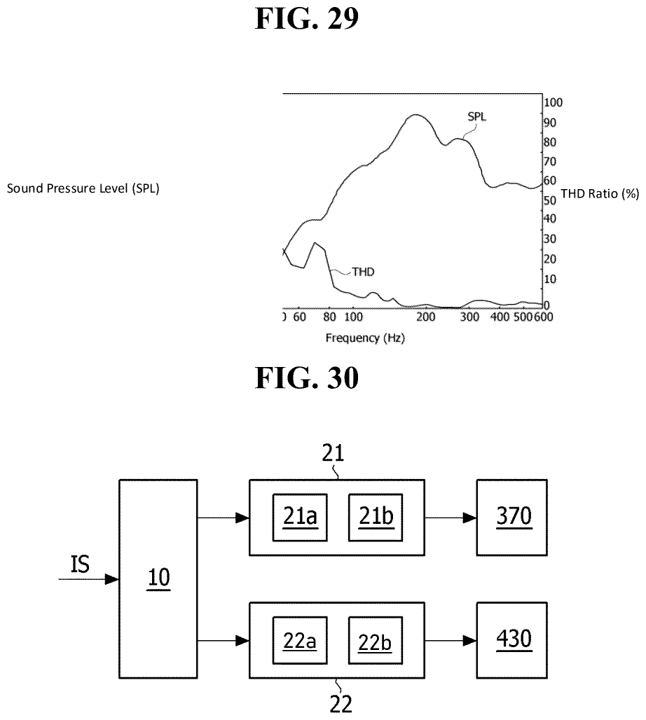

Referring to FIG. 29, the horizontal axis represents a frequency (Hz), the left vertical axis represents a sound pressure (SPL, dB), and the right vertical axis represents a total harmonic distortion ratio (THD ratio).

According to the vibration device according to the third embodiment, it can be confirmed that the sound pressure increases to about 65 dB at a primary resonant frequency of 60 Hz and the THD decreases to 30% or less. When the THD is high, peak vibrations may occur due to mutual overlap, or dip vibrations may occur due to mutual offset in a peripheral area of the vibration device, thereby deteriorating the sound pressure characteristics and sound quality characteristics.

FIG. 30 is a diagram showing a driving part according to one embodiment of the present specification.

Referring to FIG. 30, the driving part (e.g., a circuit) according to the embodiment of the present specification may include a signal separator 10 and driving signal generator 21 and 22.

The signal separator 10 may be configured to separate an input signal IS input according to the control of a host controller into a first sound band signal and a second sound band signal. For example, the signal separator 10 may separate the input signal IS into a low sound band signal and a high sound band signal and output the low and high sound band signals. For example, the signal separator 10 may be configured to separate the input signal IS into the first sound band signal and the second sound band signal based on 250 Hz, and a range of a frequency does not limit the contents of the present specification.

A first driving signal generator 21 may include a first digital-to-analog converter 21a and a first amplifier 21b. The first digital-to-analog converter 21a may be configured to convert a supplied first acoustic signal into a first analog signal and output the first analog signal. The first amplifier 21b may be configured to amplify the first analog signal supplied from the first digital-to-analog converter into a first vibration driving signal. For example, the first vibration driving signal may be supplied to the first vibration element 370 disposed on the first sub-plate 300 through a signal cable.

A second driving signal generator 22 may include a second digital-to-analog converter 22a and a second amplifier 22b. The second digital-to-analog converter 22a may be configured to convert a supplied second acoustic signal into a second analog signal and output the second analog signal. The second amplifier 22b may be configured to amplify the second analog signal supplied from the second digital-to-analog converter into a second vibration driving signal. For example, the second vibration driving signal may be supplied to the third vibration element 430 disposed on the second sub-plate 400 through a signal cable.

The driving part may further include a third driving signal generator. The third driving signal generator may supply a vibration driving signal to the second vibration element 220 disposed on the vibration member 200.

The apparatus according to the embodiment of the present specification may be applied to or included in a mobile device, a video phone, a smart watch, a watch phone, a wearable apparatus, a foldable apparatus, a rollable apparatus, a bendable apparatus, a flexible apparatus, a curved apparatus, a sliding apparatus, a variable apparatus, an electronic notebook, an e-book, a portable multimedia player (PMP), a personal digital assistant (PDA), an MP3 player, a mobile medical device, a desktop PC, a laptop PC, a netbook computer, a workstation, a navigation system, a vehicle display apparatus, a theater display apparatus, a television, a wallpaper device, a signage device, a game device, a laptop computer, a monitor, a camera, a camcorder, a home appliances, or the like. In addition, the apparatus according to one embodiment of the present specification may be applied to or included in an organic light emitting lighting apparatus or an inorganic light emitting lighting apparatus. When the apparatus is applied to a lighting device, the apparatus may function as a light and a speaker. In addition, when the apparatus according to one or more embodiments of the present specification is applied to a mobile device or the like, the apparatus may be one or more of a speaker, a receiver, and a haptic, but the embodiments of the present specification are not limited thereto.

An apparatus according to an embodiment of the present specification may be described as follows.

An apparatus according to an embodiment of the present specification may include a housing including an internal space, a plurality of first sub-plates disposed in the internal space, a plurality of first vibration elements each disposed on one of the plurality of first sub-plates, and a vibration member disposed on the plurality of first sub-plates and the plurality of first vibration elements. The plurality of first sub-plates may have one sides connected to the housing and the other sides connected to the vibration member.

According to one or more embodiments of the present specification, the apparatus may include a plurality of first transmission members connecting the plurality of sub-plates to the vibration member.

According to one or more embodiments of the present specification, a thickness of the first transmission member may be larger than a thickness of the plurality of sub-plates.

According to one or more embodiments of the present specification, a side wall portion of the housing may include a plurality of stepped portions to which the one sides of the plurality of sub-plates are connected.

According to one or more embodiments of the present specification, the apparatus may include a first coupling member connecting the vibration member to the housing, and a second coupling member connecting the one sides of the plurality of sub-plates to the plurality of stepped portions.

According to one or more embodiments of the present specification, the plurality of sub-plates may include a first-first sub-plate and a first-second sub-plate facing each other in a first direction, and a first-third sub-plate and a first-fourth sub-plate facing each other in a second direction intersecting the first direction.

According to one or more embodiments of the present specification, the other side of the first-first sub-plate and the other side of the first-second sub-plate may be spaced a first interval from each other. The other side of the first-third sub-plate and the other side of the first-fourth sub-plate may be spaced a second interval from each other.

According to one or more embodiments of the present specification, the first interval may be the same as the second interval.

According to one or more embodiments of the present specification, the first interval may differ from the second interval.

According to one or more embodiments of the present specification, the other side of the first-third sub-plate and the other side of the first-fourth sub-plate may be disposed between the first-first sub-plate and the first-second sub-plate.

According to one or more embodiments of the present specification, lengths of the first-third sub-plate and the first-fourth sub-plate may be the same as lengths of the first-first sub-plate and the first-second sub-plate.

According to one or more embodiments of the present specification, the apparatus may further include a weight member disposed between the plurality of first sub-plates and the vibration member.

According to one or more embodiments of the present specification, the first-first sub-plate to the first-fourth sub-plate may surround a central portion of the vibration member.

According to one or more embodiments of the present specification, the weight member may be disposed at a central portion.

According to one or more embodiments of the present specification, the apparatus may include a second vibration element disposed on the vibration member.

According to one or more embodiments of the present specification, the apparatus may include a plurality of second sub-plates disposed under the plurality of first sub-plates. The plurality of second sub-plates may have one sides connected to the housing and the other sides connected to the vibration member.

According to one or more embodiments of the present specification, the apparatus may include a plurality of second transmission members connecting the other sides of the plurality of second sub-plates to the vibration member.

According to one or more embodiments of the present specification, the apparatus may include a central member connecting the plurality of second transmission members to the vibration member.

According to one or more embodiments of the present specification, the plurality of first transmission members may be disposed to surround the plurality of second transmission members.

According to one or more embodiments of the present specification, the number of plurality of second sub-plates may be smaller than the number of plurality of first sub-plates.

According to one or more embodiments of the present specification, lengths of the plurality of second sub-plates may differ from or the same as lengths of the plurality of first sub-plates.

According to one or more embodiments of the present specification, materials of the plurality of second transmission members may differ from or the same as a material of the central member.

According to one or more embodiments of the present specification, the material of the central member may be made of a medium or high hardness material or a metallic material.

According to one or more embodiments of the present specification, the apparatus may further include a protruding member disposed in the housing. The one sides of the plurality of second sub-plates may be connected to the protruding member.

According to one or more embodiments of the present specification, the apparatus may further include a weight member disposed between the plurality of first sub-plates and the vibration member.

According to one or more embodiments of the present specification, the weight member may be disposed to overlap the plurality of first sub-plates.

According to one or more embodiments of the present specification, the apparatus may further include third vibration elements disposed on the second sub-plates respectively.

According to one or more embodiments of the present specification, the protruding member may be connected to the housing by a fastening member, a first wire and a second wire may be electrically connected to the first vibration elements and the third vibration element respectively through a first through hole of the protruding member.

According to one or more embodiments of the present specification, the apparatus may further include a hole disposed in a side of the housing and a duct accommodated in the hole. According to one or more embodiments of the present specification, each of the plurality of first vibration elements may include a vibration portion including a piezoelectric material, a first electrode portion disposed on a first surface of the vibration portion, and a second electrode portion disposed on a second surface different from the first surface of the vibration portion.

The above-described present specification is not limited by the above-described embodiments and the accompanying drawings, and it will be apparent to those skilled in the art to which the present specification pertains that various substitutions, modifications, and changes are possible without departing from the scope of the technical spirit of the present specification. Therefore, the scope of the present specification is determined by the appended claims, and all changes or modifications derived from the meaning and scope of the claims and equivalent concepts thereof should be construed as being included in the scope of the present specification.

### Description of Reference Numerals

100: Housing
110: Bottom portion
120: Side wall portion
124: Stepped portion
200: Vibration member
300: First sub-plate
350: First transmission member
400: Second sub-plate

What is claimed is:

1. An apparatus comprising:
a housing including an internal space;
a plurality of first sub-plates in the internal space;
a plurality of first vibration elements each disposed on one of the plurality of first sub-plates; and
a vibration member on the plurality of first sub-plates and the plurality of first vibration elements,
wherein the plurality of first sub-plates have one sides connected to the housing and other sides connected to the vibration member.

2. The apparatus of claim 1, further comprising:
a plurality of first transmission members connecting the plurality of first sub-plates to the vibration member.

3. The apparatus of claim 2, wherein a thickness of a first transmission member from the plurality of first transmission members is larger than a thickness of the plurality of first sub-plates.

4. The apparatus of claim 1, wherein a side wall portion of the housing includes a plurality of stepped portions to which the one sides of the plurality of first sub-plates are connected.

5. The apparatus of claim 4, further comprising:
a first coupling member connecting the vibration member to the housing; and
a second coupling member connecting the one sides of the plurality of first sub-plates to the plurality of stepped portions.

6. The apparatus of claim 5, wherein the first coupling member is non-overlapping with the second coupling member.

7. The apparatus of claim 1, wherein the plurality of first sub-plates include:
a first-first sub-plate and a first-second sub-plate facing each other in a first direction; and
a first-third sub-plate and a first-fourth sub-plate that face each other in a second direction intersecting the first direction.

8. The apparatus of claim 7, wherein:
the other side of the first-first sub-plate and the other side of the first-second sub-plate are spaced a first interval from each other, and
the other side of the first-third sub-plate and the other side of the first-fourth sub-plate are spaced a second interval from each other.

9. The apparatus of claim 8, wherein the first interval is a same as the second interval.

10. The apparatus of claim 8, wherein the first interval differs from the second interval.

11. The apparatus of claim 7, wherein the other side of the first-third sub-plate and the other side of the first-fourth sub-plate are between the first-first sub-plate and the first-second sub-plate.

12. The apparatus of claim 7, wherein lengths of the first-third sub-plate and the first-fourth sub-plate are a same as lengths of the first-first sub-plate and the first-second sub-plate.

13. The apparatus of claim 7, further comprising:
a weight member between the plurality of first sub-plates and the vibration member.

14. The apparatus of claim 13, wherein the first-first sub-plate to the first-fourth sub-plate surround a central portion of the vibration member.

15. The apparatus of claim 14, wherein the weight member is at the central portion.

16. The apparatus of claim 1, further comprising:
a second vibration element on the vibration member.

17. The apparatus of claim 2, further comprising:
a plurality of second sub-plates under the plurality of first sub-plates,
wherein the plurality of second sub-plates have one sides connected to the housing and the other sides connected to the vibration member.

18. The apparatus of claim 17, further comprising:
a plurality of second transmission members between the other sides of the plurality of second sub-plates and the vibration member.

19. The apparatus of claim 18, further comprising:
a central member connecting the plurality of second transmission members to the vibration member.

20. The apparatus of claim 18, wherein the plurality of first transmission members surround the plurality of second transmission members.
